(19) United States
(12) Patent Application Publication
(10) Pub. No.: US 2023/0291818 A1
(43) Pub. Date: Sep. 14, 2023

(54) NETWORK FUNCTION SERVICE INSTANCE RESELECTION ENHANCEMENT IN A 5TH GENERATION CORE NETWORK WITH INDIRECT COMMUNICATION

(71) Applicant: Telefonaktiebolaget LM Ericsson (publ), Stockholm (SE)

(72) Inventors: Yong YANG, KÅLLERED (SE); Yunjie LU, SHANGHAI (CN)

(21) Appl. No.: 18/019,171

(22) PCT Filed: Jul. 28, 2021
(86) PCT No.: PCT/EP2021/071170

§ 371 Date: Feb. 1, 2023

(30) Foreign Application Priority Data
Aug. 4, 2020 (WO) PCT/CN2020/106743
Aug. 10, 2020 (WO) PCT/CN2020/108188

(51) Int. Cl. H04L 69/40; H04L 67/51; H04L 67/561; H04W 24/04

(52) U.S. Cl. CPC H04L 69/40; H04L 67/51; H04L 67/561; H04W 24/04

(57) ABSTRACT

A first network node operating in a communications network configured to operate with indirect communication can transmit a request message addressing a first context in a first receiver to a second network node operating in the communications network. The request message can include information associated with the first context. Responsive to transmitting the request message, the first network node can receive a response message from the second network node including an identification of a second receiver associated with a second context.

### TECHNICAL FIELD

The present disclosure is related to wireless communication systems and more particularly to network function service instance reselection enhancement in a 5^{th} Generation core network with indirect communication.

### BACKGROUND

FIG. 1 illustrates an example of a 5^{th} Generation (“5G”) network including a network node 102 (e.g., a 5G base station (“gNB”)) and multiple communication devices 104 (also referred to as user equipment (“UE”)).

FIG. 2 illustrates an example of a 5G core network architecture. A network function (“NF”) instance is an identifiable instance of a NF. A NF service is a functionality exposed by a NF through a service based interface and consumed by other authorized NFs. A NF service instance is an identifiable instance of the NF service. A NF service operation i an elementary unit a NF service is composed of. A NF service set is a group of interchangeable NF service instances of the same service type within an NF instance. The NF service instances in the same NF service set can have access to the same context data. A NF set is a group of interchangeable NF instances of the same type, supporting the same services and the same network slice. The NF instances in the same NF set may be geographically distributed but have access to the same context data.

### SUMMARY

According to some embodiments, a method of operating a first network node in a communications network configured to operate with indirect communication is provided. The method can include transmitting a request message addressing a first context in a first receiver to a second network node operating in the communications network. The request message can include information associated with the first context. The method can further include, responsive to transmitting the request message, receiving a response message from the second network node including an identification of a second receiver associated with a second context.

According to other embodiments, a method of operating a second network node in a communications network configured to operate with indirect communication is provided. The method can include receiving a first request message addressing a first context in a first receiver from a first network node operating in the communications network. The first request message can include first information associated with the first receiver. The method can further include determining a failure event has occurred in association with the first receiver. The method can further include, responsive to determining that the failure event has occurred, transmitting a discovery request message to a network repository function, NRF. The discovery request message can request an indication of a receiver capable of serving a second context as the first receiver serves the first context and the discovery request message including second information based on the first information. The method can further include, responsive to transmitting the discovery request message, receiving a discovery response message from the NRF, the discovery response message including a list of receivers. The method can further include selecting a second receiver from the list of receivers. The method can further include, responsive to selecting the second receiver, transmitting a second request message to the second receiver, the second request message based on the first request message. The method can further include, responsive to transmitting the second request message, receiving a first response message from the second receiver. The method can further include, responsive to receiving the first response message, transmitting a second response message to the first network node, the second response message including an identification of the second receiver.

According to other embodiments, a first network node, a second network node, computer program, and/or computer program product is provided for performing one or more of the above methods.

In various embodiments described herein, enable a service community proxy (“SCP”) to perform a reselection of the receiver (either a service producer or a service consumer) in 5GC when indirect communication is deployed

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a block diagram illustrating an example of 5G system architecture;

FIG. 3 is a block diagram illustrating an example of direct communication between network functions (“NFs”) of a 5G system;

FIG. 4 is a block diagram illustrating an example of indirect communication between network functions (“NFs”) of a 5G system;

FIG. 5 is a table illustrating an example of communication models for NF/NF service interactions;

FIGS. 6-9 are block diagrams illustrating examples of the communication models illustrated in the table of FIG. 5;

FIG. 10 is a signal flow diagram illustrating an example of a request-response NF procedure;

FIG. 11 is a signal flow diagram illustrating an example of a direct communication subscribe-notify NF procedure;

FIG. 12 is a signal flow diagram illustrating an example of an indirect subscribe-notify NF procedure;

FIG. 13 is a signal flow diagram illustrating an example of a request-response NF procedure in which an access and mobility management function (“AMF”) selects the target session management function (“SMF”) in accordance with some embodiments;

FIG. 14 is a signal flow diagram illustrating an example of a request-response NF procedure in which the service communication proxy (“SCP”) selects the target SMF in accordance with some embodiments;

FIG. 15 is a signal flow diagram illustrating an example of a SCP selecting an alternate SMF in response to a failure in accordance with some embodiments;

FIG. 16 is a block diagram illustrating an example of a communication device in accordance with some embodiments;

FIG. 17 is a block diagram illustrating an example of a radio access network (“RAN”) node in accordance with some embodiments;

FIG. 18 is a block diagram illustrating an example of a core network (“CN”) node in accordance with some embodiments;

FIGS. 19-20 are flow charts illustrating examples of processes performed by a first network node (e.g., an AMF node) in accordance with some embodiments;

FIGS. 21-22 are flow charts illustrating examples of a process performed by a second network node (e.g., a SCP node) in accordance with some embodiments; and

FIG. 23 is a table illustrating an example of NF service discovery factor headers in accordance with some embodiments.

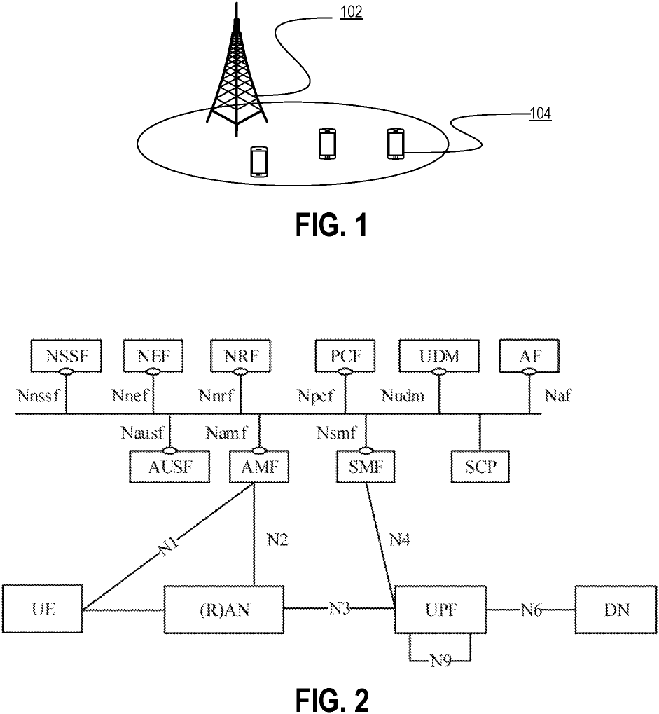

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The 3^{rd} Generation Partnership Project (“3GPP”) has expanded the use of the Network Function Set concept to be applicable for all type of Network Functions in 5G Core. A NF instance can be deployed such that several network function instances are present within a NF set to provide distribution, redundancy, and scalability together as a set of NF instances. Therefore, a NF can be replaced by an alternative NF within the same NF set in case of scenarios such as failure, load balancing, and/or load re-balancing.

In case of failure of a NF (service) instance, or failure to perform load re-balancing, the peer NF can use a “Binding Indication” to select an alternative NF (service) instance.

A binding can be used to indicate suitable target NF producer instance(s) for NF service instance selection, reselection, and routing of subsequent requests associated with a specific NF producer resource (context) and NF service. This allows the NF producer to indicate that the NF consumer, for a particular context, should be bound to an NF service instance, NF instance, NF service set or NF set depending on local policies and other criteria (e.g. at what point it is in the middle of a certain procedure, considering performance aspects etc).

Binding can also be used by the NF consumer to indicate suitable NF consumer instance(s) for notification target instance reselection and routing of subsequent notification requests associated with a specific notification subscription and for providing Binding Indication for service(s) that the NF consumer produces for the same data context and the NF service producer is subsequently likely to invoke.

The binding indication can be information included by a NF service producer to a NF service consumer in request responses or notifications to convey the scope within which selection/reselection of target NF/NF services may be performed, or information included by the NF service consumer in requests or subscriptions to convey the scope within which selection/reselection of notification targets or the selection of other service(s) that the NF consumer produces for the same data context may be performed.

The Binding Indication can be defined as a 3GPP custom http header as described in TS 29.500.

“Indirect Communication” is described below.

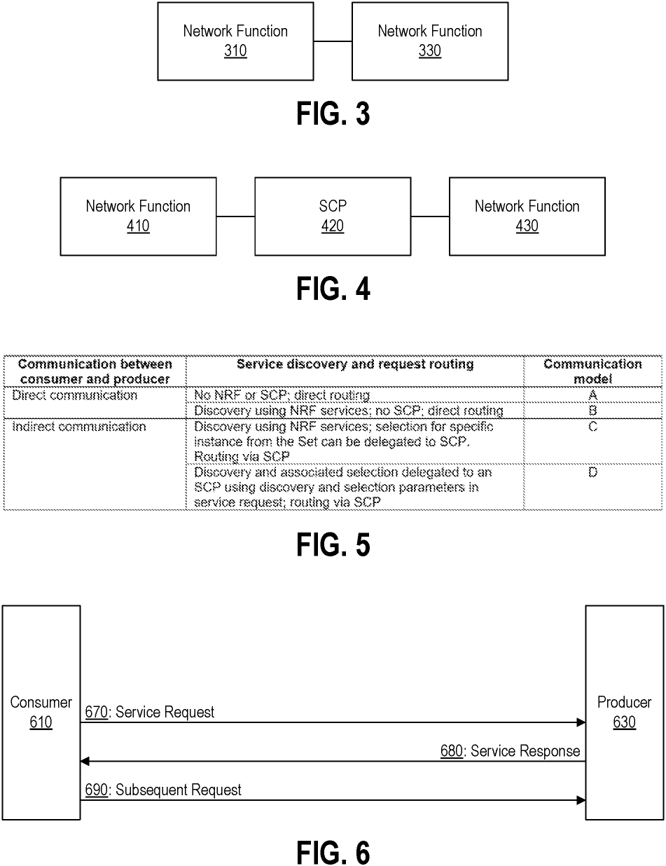

NF services may communicate directly between NF Service consumers and NF Service Producers, or indirectly via an SCP. FIGS. 3-4 illustrate examples of direct and indirect communication respectively.

### FIG. 3

In FIG. 3, a first NF 310 has a direct communication path to a second NF 330. In some examples, the first NF 310 is in a first network node (e.g., a radio access network (“RAN”) node) and the second NF 330 is in a second network node. In direct communication, the NF Service consumer (here illustrated as NF 310) performs discovery of the target NF Service producer (here illustrated as NF 330) by local configuration or via a NRF. The NF Service consumer can communicate with the target NF service producer directly.

### FIG. 4

In FIG. 4, a first NF 410 has an (indirect) communication path to a second NF 430 via service community proxy (“SCP”) 420. In some examples, the SCP can be deployed in a distributed manner. In Indirect Communication, the NF Service consumer (here illustrated as NF 410) can communicate with the target NF service producer (here illustrated as NF 430) via a SCP 420. The NF service consumer may be configured to perform discovery of the target NF service producer directly, or delegate the discovery of the target NF service producer to the SCP used for indirect communication. In the latter case, the SCP can use the parameters provided by NF service consumer to perform discovery and/or selection of the target NF service producer. The SCP address may be locally configured in NF service consumer.

A routing binding indication may be included in a request, subscribe or notification messages. It can be used in the case of indirect communication by the SCP to route the message. The Routing Binding Indication can be a copy of the information in the Binding Indication.

During NF service discovery and (re)selection aspects relevant with indirect communication, the SCP can perform the following functionalities regarding NF and NF service discovery and selection. If the request includes a routing binding indication, the SCP can route the service request to the requested target. If the routing binding indication does not exist, the SCP may get the NF Set ID from the NRF or local configuration (if available). If the request recipient had previously provided a binding indication, then the request sender can include a routing Binding indication with the same contents in subsequent related requests.

### FIG. 5

The table in FIG. 5 provides a high level description of the different communication models that NF and NF services can use to interact which each other. FIGS. 6-9 further illustrate each of the different communication models individually.

### FIG. 6

FIG. 6 illustrates Model A, which describes direct communication without NRF interaction. In model A, neither NRF nor SCP are used. Consumers are configured with producers’ “NF profiles” and directly communicate with a producer of their choice. In this example, consumer 610 directly communicates with producer 630. At operation 640, the consumer 610 transmits a service request directly to the producer 630. At operation 650, the producer 630 transmits a service response directly to the consumer 610. At operation 660, the consumer 610 transmits a subsequent request directly to the producer 630.

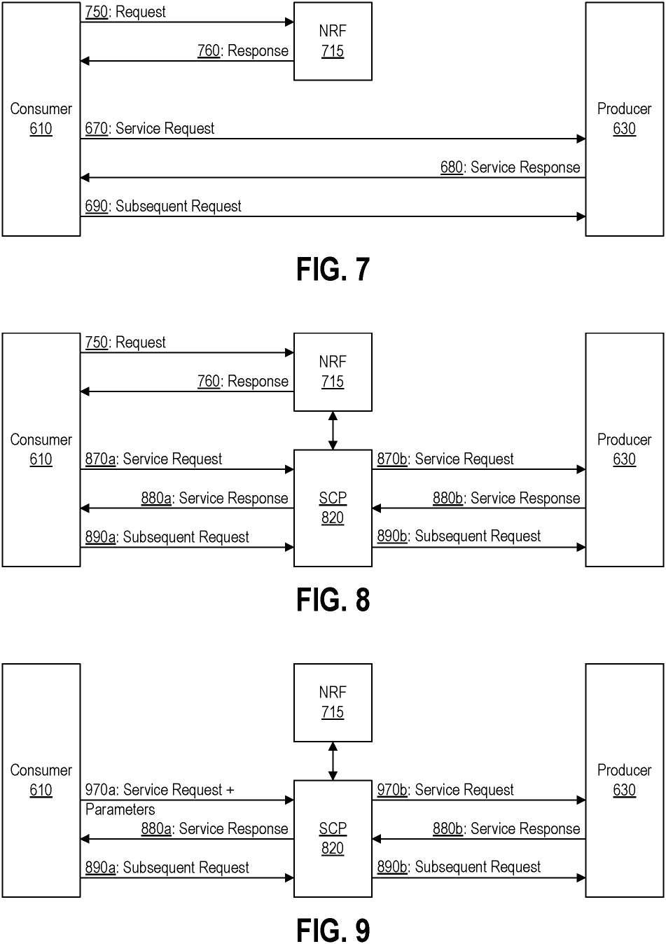

### FIG. 7

FIG. 7 illustrates Model B, which describes direct communication with NRF interaction. In this example, the consumer 610 performs discovery during operations 750 and 760 by transmitting a request to the NRF 715 and receiving a response from the NRF. Based on the discovery result, the consumer 610 does the selection. The consumer 610 then performs operations 670, 680, and 690 similarly to in FIG. 6.

### FIG. 8

FIG. 8 illustrates Model C, which describes indirect communication without delegated discovery. Similarly to in FIG. 7, the consumer 610 can perform discovery by querying the NRF 715 in operations 750 and 760. Based on the discovery result, the consumer 610 selects an NF set or a specific NF instance of the NF instance set. At operation 870a, the consumer 610 can send the request to the SCP 820 including the address of the selected service producer pointing to a NF service instance or a set of NF service instances. In the latter case, the SCP 820 selects an NF service instance. If possible, the SCP 820 interacts with NRF 715 to get selection parameters such as location and capacity. At operation 870b, the SCP 820 routes the request to the selected NF service producer instance (here producer 630). Operations 880a-b are similar to operation 680 in FIGS. 6-7 except the service response is transmitted from the producer 630 to the consumer 610 via SCP 820. Operations 890a-b are similar to operation 690 in FIGS. 6-7 except the subsequent request is transmitted from the consumer 610 to the producer 630 via SCP 820.

For indirect communication without delegated discovery, the NF service consumer can perform the discovery procedure by querying the NRF and the selection of a NF (service) set or a specific NF (service) instance. The selection of the target NF service instance may be done either by the NF service consumer or the SCP (e.g. based on NF (service) set information received from the NF service consumer).

In some examples, the NF service consumer can transmit its request to the SCP including: the 3gpp-Sbi-Target-apiRoot header set to the apiRoot of the selected NF service instance, if the SCP is known to the NF Service Consumer and if the NF Service Consumer has selected a specific NF service instance; and the identity of the selected NF (Service) Set in the associated “3gpp-Sbi-Discovery-*” request header(s) (see clause 6.10.3.2), if the NF Service Consumer has selected a target NF (Service) Set ID.

If the request does not include the apiRoot of a selected NF service instance, or if the SCP needs to reselect a different NF service instance, the SCP can select an NF service instance using the NF (service) set ID received in the corresponding “3gpp-Sbi-Discovery-*” request header(s), if available.

The SCP can then route the request to the selected NF service instance of the target NF service producer.

### FIG. 9

FIG. 9 illustrates Model D, which describes indirect communication with delegated discovery. In this example, the consumer 610 does not do any discovery or selection. Instead, at operation 970a, the consumer 610 adds any necessary discovery and selection parameters required to find a suitable producer to the service request and transmits both to the SCP 820. At operation 970b, the SCP 820 uses the request address and the discovery and selection parameters in the request message to route the request to a suitable producer instance (here producer 630). In some examples, the SCP 820 can perform discovery with the NRF 715 and obtain a discovery result. Operations 880a-b and 890a-b are similar to the same operations in FIG. 8.

When the NF service consumer is configured to use delegated service discovery (as in FIG. 9), it can include in the HTTP/2 request message the necessary NF service discovery factors to be used by the SCP to perform NF service discovery procedures on behalf of the NF service consumer. The latter can convey these NF service discovery factors using the″3gpp-Sbi-Discovery-*” request headers.

When receiving from the NF service consumer a service request containing “3gpp-Sbi-Discovery-*” request headers, and the SCP is to invoke NF service discovery towards the NRF to fulfil this task, then it can take into account all the NF service discovery factors contained in the “3gpp-Sbi-Discovery-*” request headers. It is also possible for the SCP to be internally configured to fulfil these service discovery tasks without interacting with the NRF.

If the service request includes a “3gpp-Sbi-Discovery-*” request header that is not supported by the SCP, the latter can include the corresponding query parameters in the discovery request to the NRF. Based on operator policy, the SCP may alternatively reject the request and return a response with the status code “400 Bad Request” to the NF service consumer with an “INVALID_DISCOVERY_PARAM” error.

An NF may register default notification subscriptions in its NF profile or NF services in the NRF for notifications the NF is prepared to consume, including for each type of notification the corresponding notification endpoint (i.e. callback URI). This can be used, for example, by an AMF to discover the notification endpoint of other AMFs to forward N1 or N2 messages, or by an AMF to notify location information to a GMLC, or by an UDR to notify data change or removal to an UDM.

The following procedures may be used to support notifications corresponding to default notification subscriptions. In some examples, an NF producer may perform a discovery request towards the NRF (possibly through an SCP) to discover default notification subscriptions of an NF consumer, and if so, send notifications to the corresponding notification endpoints, using routing mechanisms. In other examples, an NF producer may be configured with the types of notifications corresponding to default notification subscriptions it needs to generate, and send such notifications using delegated discovery, i.e with an SCP discovering and selecting an NF service consumer with a corresponding default notification subscription. To enable the latter, the NF producer can include in the notification request: the 3gpp-Sbi-Callback header including the name of the notify or callback service operation and the API major version if higher than 1; the 3gpp-Sbi-Discovery-notification-type header set to the type of notification being set; the 3gpp-Sbi-Discovery-target-nf-type header indicating the type of the consumer NF; and/or an additional NF service discovery factors header to be used by the SCP to discover and select the consumer NF.

When using delegated discovery, if and only if the NF Service Producer does not return a client binding indication in a service response creating a resource, the SCP can include the 3gpp-Sbi-Producer-Id header in the HTTP response it forwards to the NF Service Consumer, containing the NF Instance ID of the NF Service Producer selected by the SCP. This can allow support for deployments where not all NF Service Producers have been upgraded to support the binding procedures. In examples where the same NF Service Producer needs to be selected when creating new resources, e.g. when the AMF needs to establish a new PDU session towards the same SMF as the one selected for a previous PDU session, the NF Service Consumer can include the 3gpp-Sbi-Discovery-target-nf-instance-id header set to the NF Instance ID of the NF Service Producer in the request creating the new resource.

However, for communication models C and D, it is not clear, in the subsequent request message addressing an existing resource context in the service producer or an existing session context in the Service consumer (to receive Notification Request message), what parameters the SCP can use to perform a reselection of an alternative endpoint, if the binding indication is not supported/provided by the receiver earlier (e.g., the service producer or service consumer). For example, the binding indication of the receiver may not be available if it is the first communication towards the receiver of if the receiver doesn’t support the binding indication at all.

When the binding indication provided by the receiver (regardless of if the receiver is a service producer or a service consumer) is available, the sender of a request message (either a service request (e.g. update) to send the service producer or a notification request sent to a service consumer), can include a routing binding indication, which is a copy of the binding indication sent earlier by the receiver. The SCP can use the routing binding indication to (re)select an alternative receiver if the original receiver is not reachable.

During an initiate establishment of resource context, 3gpp-Sbi-Discovery-target* can be used, for both Model C and Model D.

For indirect communication without delegation (Model C), for initial establishment of a resource context in the service provider, if the service consumer has selected a specific service instance (e.g., instead of selecting a NF (service) set), there may be no way for the SCP to perform a reselection if the NF service instance selected by the Service Consumer is not reachable.

Therefore, there are problems for reselection (performed by the SCP) when binding indication is not available, during either: initial resource context establishment towards a NF consumer selected service producer while the service producer is not reachable, in communication model C; or an communication towards an existing resource/session context in the service producer/consumer, this is regardless if it is communication mode C or D.

Various embodiments herein enable the SCP to perform a reselection of the receiver (either a service producer or a service consumer) in 5GC when indirect communication is deployed.

In some embodiments, when sending subsequent messages addressing an existing resource context in the service producer or an existing session context in the service consumer (to receive Notification Request message) but the receiver didn’t provide any binding indication(3gpp-sbi-binding) the sender (either a service consumer (to send an update request) or a service producer (to send a notification request)), provide the following parameters as http custom header in the request message, to enable SCP to perform a reselection of an alternative endpoint, if the intended receiver has failed. In some examples, the sender generates a “3gpp-sbi-routing-binding” (for the receiver) with the binding level set to NF service set or NF set, and include NF service set id if available or NF set id if available ON ITS OWN. In additional or alternative examples, the sender generates “3gpp-sbi-discovery-target-nf-instance-id″ + ““3gpp-sbi-discovery-service-names” for the receiver.

In some embodiments, the sender can only copy the binding indication received from the receiver earlier into routing binding indication, to be used by the SCP(s).

In additional or alternative embodiments, when binding indication of the receiver is not available, the sender can make the following assumptions. If the NF (service) instance is pertaining to a NF (service) set, when another NF (service) instance in the same NF (service) set can serve the same resource context. The SCP, at receiving “3gpp-sbi-routing-binding” or “3gpp-sbi-discovery-target-nf-instance-id”, can retrieve the NF service set or NF set via initiating Service Discovery procedure towards NRF using the target NF instance Id and service name. The SCP can consider first to select an alternative service instance in the same service set if available/as defined in the NF profile (identified by the target-nf-instance-id). If not, it selects another NF in the same NF set.

In some examples, target NF instance Id and NF service name are included in either “3gpp-sbi-routing-binding” or provisioned using both “3gpp-sbi-discovery-target-nf-instance-id”, “3gpp-sbi-discovery-service-names”.

In some embodiments, for communication model C (service discovery without delegation) when the service consumer has selected an exact service instance for an initial establishment of a resource context in the service producer, in such case, the service consumer includes: “3gpp-sbi-discovery-target-nf-instance-id″ + ““3gpp-sbi-discovery-service-names” in order to let SCP to select an alternative if the one selected by the consumer is not reachable; or “3gpp-sbi-routing-indication” in order to let SCP to select an alternative.

For communication mode C, without delegation, it may be more reasonable to use “3gpp-sbi-routing-binding”; while for communication mode D with service discovery delegation, it may be more reasonable to use “3gpp-sbi-discovery-target-nf-id” + “3gpp-sbi-discovery-service-names”.

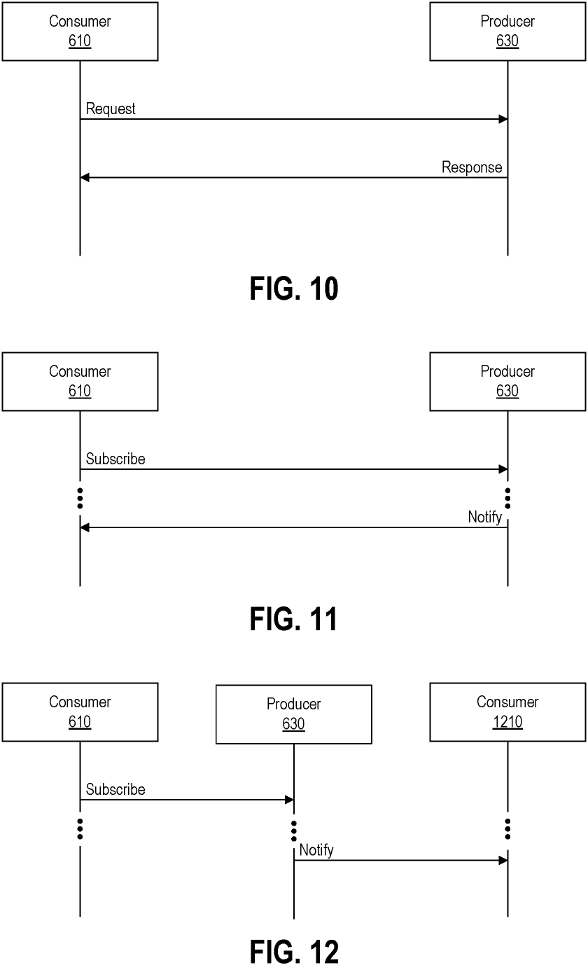

FIGS. 10-11 are signal flow diagrams illustrating examples of direct communications between a consumer 610 and a producer 630.

### FIG. 10

In FIG. 10, the consumer 610 and producer 630 exchange a request and response signal.

### FIG. 11

In FIG. 11, the consumer 610 and producer 630 exchange a subscribe and notify message.

### FIG. 12

FIG. 12 is a signal flow diagram illustrating an example of an indirect communication between a consumer 610, a producer 630, and another consumer 1210. In this example, a subscribe message is transmitted from the consumer 610 to a producer 630, which transmits a notify message to consumer 1210.

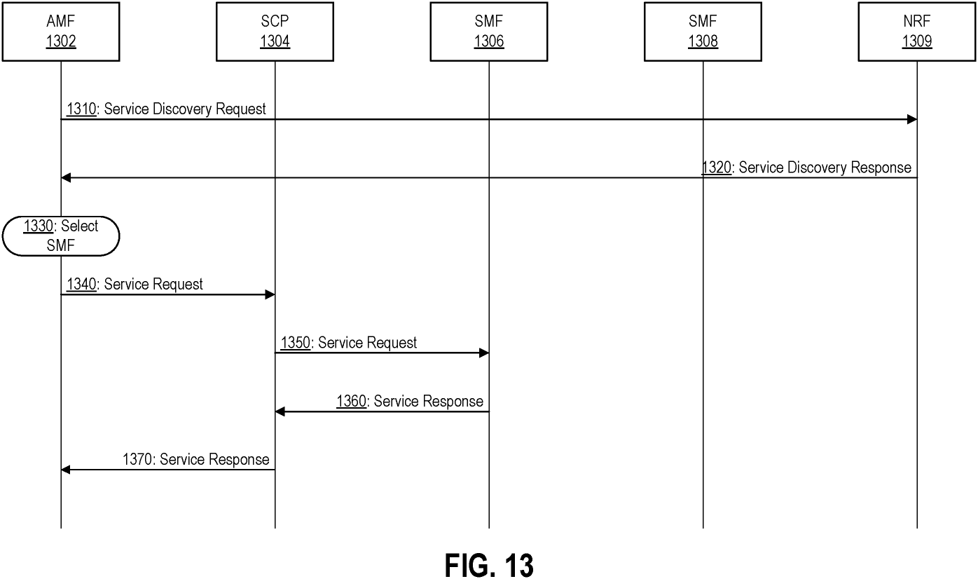

### FIG. 13

FIG. 13 is a signal flow diagram illustrating an example of a request-response NF procedure in which an access and mobility management function (“AMF”) 1302 selects the target session management function (“SMF”) 1306 in accordance with some embodiments.

At operation 1310, AMF 1302 transmits a service discovery request to NRF 1309. In some embodiments, the service discovery request includes a request to find a service provider (e.g., a SMF) to provide a service (e.g., consume a Nsmf_PDUSession service). In additional or alternative embodiments, the service discovery request includes a list of discovery parameters indicating characteristics of the service provider.

At operation 1320, NRF 1309 transmits a service discovery response to AMF 1302. In some embodiments, the service discovery response includes a list of service providers (e.g., SMF NF profiles) that can perform the service for a communication device associated with the AMF 1302. In additional or alternative embodiments, the list of service providers can include NF service set IDs and NF set IDs associated with each service provider.

At operation 1330, the AMF 1302 selects the SMF 1306. In some embodiments, the AMF 1302 selects the SMF 1306 from the list of service providers.

At operation 1340, the AMF 1302 transmits the service request to the SCP 1304. In some embodiments, the service request includes a request for creating a resource in SMF 1306′s service instance. In additional or alternative embodiments, the service request includes 3gpp-sbi-discvoery-target-nf-id and 3gpp-sbi-discovery-service-name (which can be used by the SCP 1304 if reselection is needed).

At operation 1350, the SCP 1304 transmits a service request to the SMF 1306. At operation 1360, the SMF 1306 transmits a service response to the SCP 1304. In some embodiments, the service response includes a location header of the created resource. In additional or alternative embodiments, the service request may not include a binding indication. At operation 1370, the SCP 1304 transmits a service response to the AMF 1302. In some embodiments, the service request is based on the service request received from the SMF 1306 and includes an identifier of the SMF 1304 (e.g., a 3gpp-producer-id).

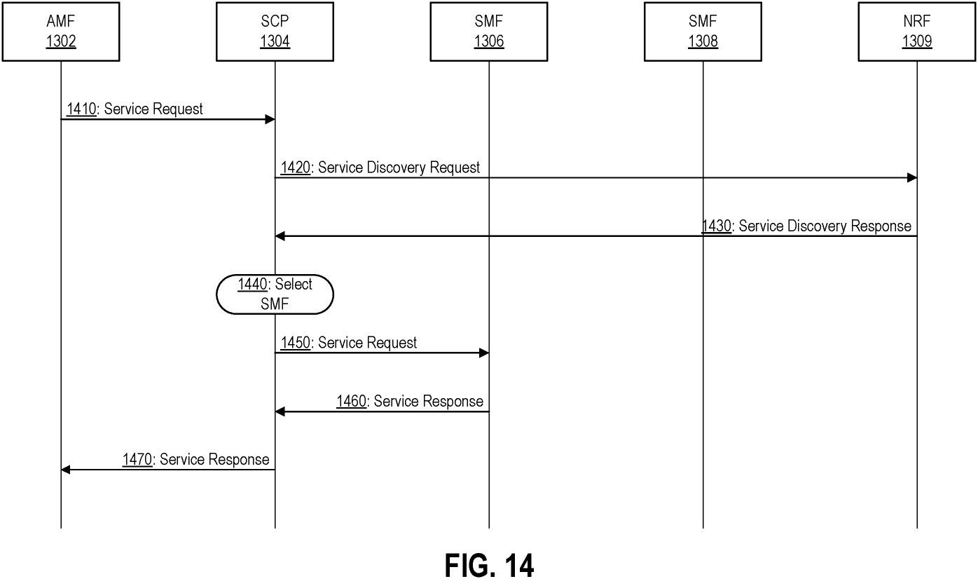

### FIG. 14

FIG. 14 is a signal flow diagram illustrating an example of a request-response NF procedure in which the service communication proxy (“SCP”) 1304 selects the target SMF 1306 in accordance with some embodiments.

At operation 1410, the AMF 1302 transmits a service request to the SCP 1304. In some embodiments, the service request includes a request for creating a resource. In additional or alternative embodiments, the service request includes 3gpp-sbi-discovery-target-nf-type, 3gpp-sbi-discovery-service-name, and 3gpp-sbi-discvoery-dnn.

At operation 1420, the SCP 1304 transmits a service discovery request to the NRF 1309. In some embodiments, the SCP discovery request can be based on the information in the service request.

At operation 1430, the NRF 1309 transmits a service discovery response to the SCP 1304. In some embodiments, the service discovery response includes a list of service providers (e.g., SMF NF profiles) that can perform the service for a communication device associated with the AMF 1302. In additional or alternative embodiments, the list of service providers can include NF service set IDs and NF set IDs associated with each service provider.

At operation 1440, the SCP 1304 selects the SMF 1306. In some embodiments, the SCP 1304 selects the SMF 1306 from the list of service providers.

At operation 1450, the SCP 1304 transmits a service request to the SMF 1306. At operation 1460, the SMF 1306 transmits a service response to the SCP 1304. In some embodiments, the service response includes a location header of the created resource. In additional or alternative embodiments, the service request may not include a binding indication. At operation 1470, the SCP 1304 transmits a service response to the AMF 1302. In some embodiments, the service request is based on the service request received from the SMF 1306 and includes an identifier of the SMF 1304 (e.g., a 3gpp-producer-id).

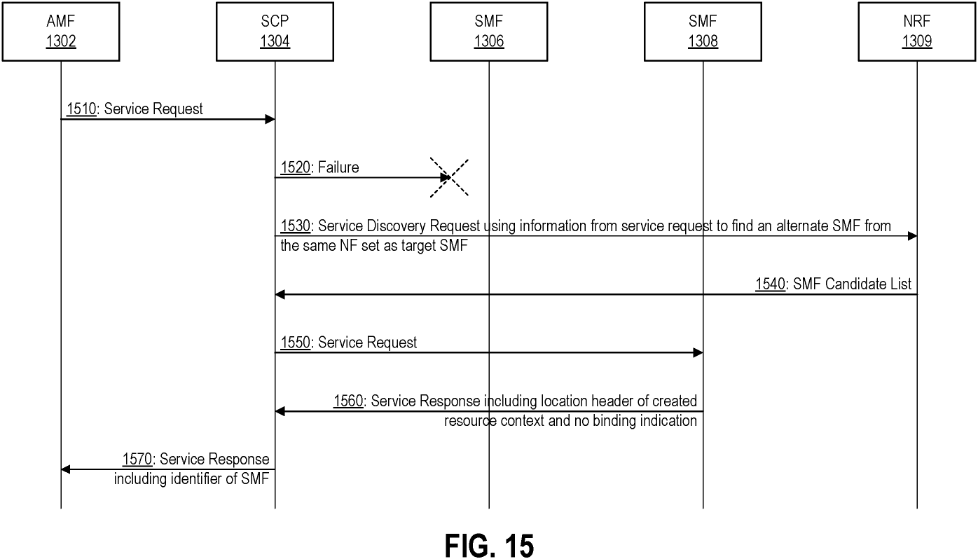

### FIG. 15

FIG. 15 is a signal flow diagram illustrating an example of a SCP 1304 selecting an alternate SMF 1306 in response to a failure in accordance with some embodiments.

At operation 1510, AMF 1302 transmits a service request to SCP 1304. In some embodiments, the service request includes a request to create a resource. In additional or alternative embodiments, the service request includes information associated with the service provider (e.g., SMF 1304), for example, 3gpp-sbi-discovery-target-nf-id, 3gpp-sbi-discovery-service-name, and 3gpp-sbi-discovery-dnn.

In additional or alternative embodiments, the service request includes a request to update the resource. In additional or alternative embodiments, the service request includes information associated with the service provider (e.g., SMF 1304), for example, 3gpp-sbi-discovery-target-nf-id and 3gpp-sbi-discovery-service-name.

At operation 1520, SCP 1304 fails to communicate with the SMF 1306. In some embodiments, failing to communicate with the SMF includes determining that a failure event associated with the SMF 1306 has occurred.

At operation 1530, SCP 1304 transmits a service discovery request to NRF 1309. In some embodiments, the service discovery request includes information from the service request to find an alternate SMF from the same NF set as the SMF 1306.

At operation 1540, NRF 1309 transmits a service discovery response to SCP 1304. In some embodiments, the service discovery response include a candidate list of potential service providers including SMF 1308.

At operation 1550, SCP 1304 transmits a service request to the SMF 1308. In some embodiments, the service request is based on the service request received from the AMF 1302 and includes an indication for the SMF 1308 to create a resource for providing the service previously provided by SMF 1306.

At operation 1560, SMF 1308 transmits a service response to the SCP 1304. In some embodiments, the service response includes a location header of the created resource. In additional or alternative embodiments, the service response may not include a binding indication.

At operation 1570, SCP 1304 transmits a service response to the AMF 1302. In some embodiments, the service response includes the information received in the service response by the SMF 1308. In additional or alternative embodiments, the service response also includes a identification of SMF 1308 (e.g., 3gpp-producer-id).

Although FIGS. 13-15 illustrate examples of a consumer selecting/reselecting a producer, similar operations can be performed to select/reselect a consumer. For example, a producer (also referred to as a service provider) may transmit information to a SCP such that if the SCP detects a failure event associated with a first consumer, then the SCP can select a new consumer based on the information even if the first consumer had not provided the SCP with a binding indication.

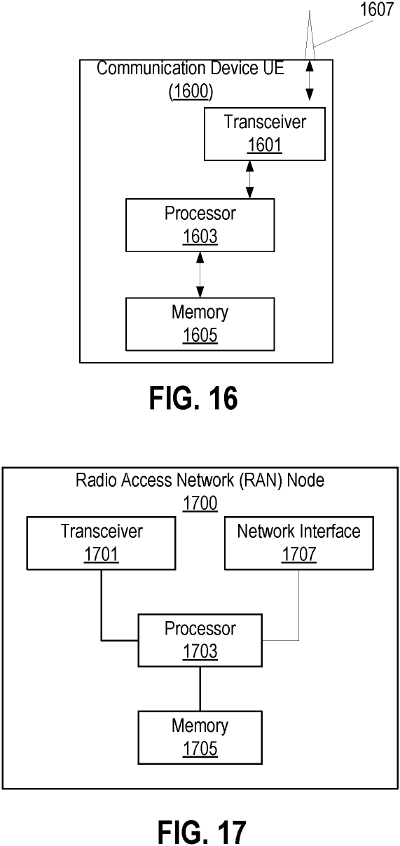

### FIG. 16

FIG. 16 is a block diagram illustrating elements of a communication device 1600 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 1600 may be provided. As shown, communication device 1600 may include an antenna 1607, and transceiver circuitry 1301 (also referred to as a transceiver) including a transmitter and a receiver configured to provide uplink and downlink radio communications with a base station(s) (also referred to as a RAN node) of a radio access network. Communication device 1600 may also include processing circuitry 1603 (also referred to as a processor) coupled to the transceiver circuitry, and memory circuitry 1605 (also referred to as memory) coupled to the processing circuitry. The memory circuitry 1605 may include computer readable program code that when executed by the processing circuitry 1603 causes the processing circuitry to perform operations according to embodiments disclosed herein. According to other embodiments, processing circuitry 1603 may be defined to include memory so that separate memory circuitry is not required. Communication device 1600 may also include an interface (such as a user interface) coupled with processing circuitry 1603, and/or communication device UE may be incorporated in a vehicle.

As discussed herein, operations of communication device 1600 may be performed by processing circuitry 1603 and/or transceiver circuitry 1601. For example, processing circuitry 1603 may control transceiver circuitry 1601 to transmit communications through transceiver circuitry 1601 over a radio interface to a radio access network node (also referred to as a base station) and/or to receive communications through transceiver circuitry 1601 from a RAN node over a radio interface. Moreover, modules may be stored in memory circuitry 1605, and these modules may provide instructions so that when instructions of a module are executed by processing circuitry 1603, processing circuitry 1603 performs respective operations.

### FIG. 17

FIG. 17 is a block diagram illustrating elements of a radio access network (“RAN”) node 1700 (also referred to as a network node, base station, eNodeB/eNB, gNodeB/gNB, etc.) of a Radio Access Network (RAN) configured to provide cellular communication according to embodiments of inventive concepts. As shown, the RAN node 1700 may include transceiver circuitry 1701 (also referred to as a transceiver) including a transmitter and a receiver configured to provide uplink and downlink radio communications with mobile terminals. The RAN node 1700 may include network interface circuitry 1707 (also referred to as a network interface) configured to provide communications with other nodes (e.g., with other base stations) of the RAN and/or core network CN. The RAN node 1700 may also include processing circuitry 1703 (also referred to as a processor) coupled to the transceiver circuitry, and memory circuitry 1705 (also referred to as memory) coupled to the processing circuitry. The memory circuitry 1705 may include computer readable program code that when executed by the processing circuitry 1703 causes the processing circuitry to perform operations according to embodiments disclosed herein. According to other embodiments, processing circuitry 1703 may be defined to include memory so that a separate memory circuitry is not required.

As discussed herein, operations of the RAN node 1700 may be performed by processing circuitry 1703, network interface 1707, and/or transceiver 1701. For example, processing circuitry 1703 may control transceiver 1701 to transmit downlink communications through transceiver 1701 over a radio interface to one or more mobile terminals UEs and/or to receive uplink communications through transceiver 1701 from one or more mobile terminals UEs over a radio interface. Similarly, processing circuitry 1703 may control network interface 1707 to transmit communications through network interface 1707 to one or more other network nodes and/or to receive communications through network interface from one or more other network nodes. Moreover, modules may be stored in memory 1705, and these modules may provide instructions so that when instructions of a module are executed by processing circuitry 1703, processing circuitry 1703 performs respective operations.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

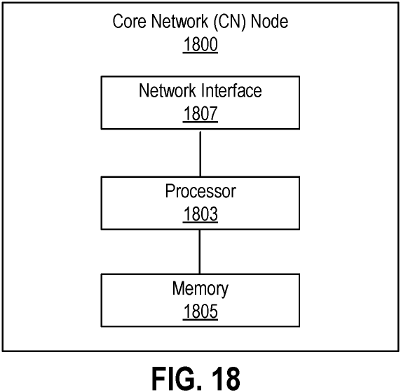

### FIG. 18

FIG. 18 is a block diagram illustrating elements of a core network (“CN”) node 1800 (e.g., an SMF node, an AMF node, an AUSF node, a UDM node, etc.) of a communication network configured to provide cellular communication according to embodiments of inventive concepts. As shown, the CN node 1800 may include network interface circuitry 1807 (also referred to as a network interface) configured to provide communications with other nodes of the core network and/or the RAN. The CN node 1800 may also include a processing circuitry 1803 (also referred to as a processor) coupled to the network interface circuitry, and memory circuitry 1805 (also referred to as memory) coupled to the processing circuitry. The memory circuitry 1805 may include computer readable program code that when executed by the processing circuitry 1803 causes the processing circuitry to perform operations according to embodiments disclosed herein. According to other embodiments, processing circuitry 1803 may be defined to include memory so that a separate memory circuitry is not required.

As discussed herein, operations of the CN node 1800 may be performed by processing circuitry 1803 and/or network interface circuitry 1807. For example, processing circuitry 1803 may control network interface circuitry 1807 to transmit communications through network interface circuitry 1807 to one or more other network nodes and/or to receive communications through network interface circuitry from one or more other network nodes. Moreover, modules may be stored in memory 1805, and these modules may provide instructions so that when instructions of a module are executed by processing circuitry 1803, processing circuitry 1803 performs respective operations.

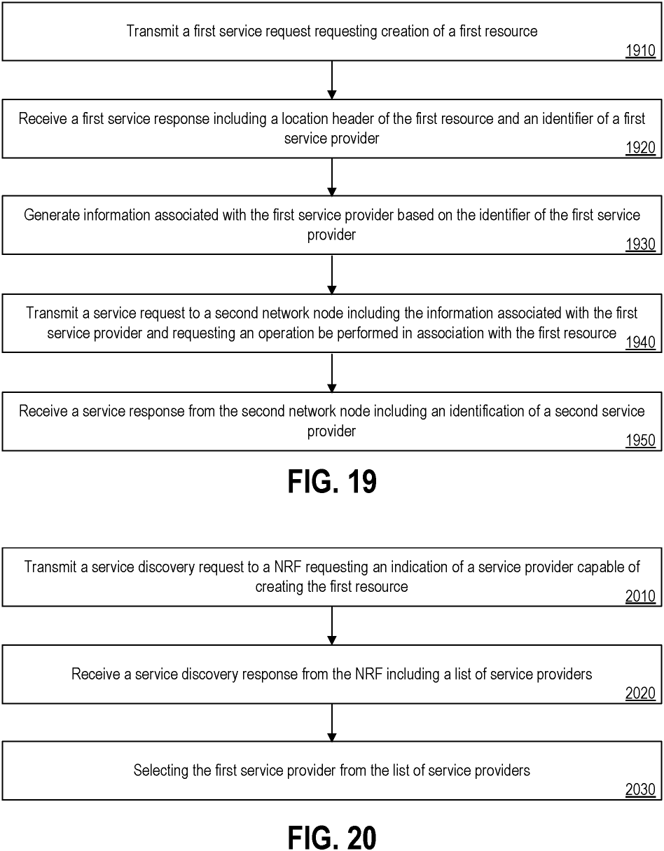

Operations of a first network node will now be discussed with reference to the flow charts of FIGS. 19-20 according to some embodiments of inventive concepts. FIGS. 19-20 will be described below as being performed by a network node (e.g., a core network node including an AMF) as implemented using the structure of the block diagram of FIG. 18). For example, modules may be stored in memory 1805 of FIG. 18, and these modules may provide instructions so that when the instructions of a module are executed by respective processing circuitry 1803, processing circuitry 1803 performs respective operations of the flow charts. However, the operations in FIGS. 19-20 may be performed by any suitable network node.

### FIG. 19

FIG. 19 illustrates an example of operations performed by a first network node (e.g., an AMF node) in accordance with some embodiments.

At block 1910, processing circuitry 1803 transmits, via network interface 1807, a first request message that requests initialization of a first context. In some embodiments, the first request message indicates that a second network node select a receiver capable of serving the first context. In additional or alternative embodiments, the first request message includes a 3gpp-sbi-routing-indication.

In some embodiments, the existing context is a new context and the first request message indicates a first receiver for serving the new context.

### FIG. 20

FIG. 20 illustrates an example of operations performed by the first network node in selecting the first receiver. At block 2010, processing circuitry 1803 transmits, via network interface 1807, a discovery request message to a NRF requesting an indication of a receiver capable of handling the new context. At block 2020, processing circuitry 1803 receives, via network interface 1807, a discovery response message from the NRF including a list of receivers. At block 2030, processing circuitry 1803 selects the first receiver from the list of receivers.

### FIG. 19 (cont.)

Returning to FIG. 19, at block 1920, processing circuitry 1803 receives, via network interface 1807, a first response message including a location header of the first context and an identifier of a first receiver.

At block 1930, processing circuitry 1803 generates information associated with the first receiver based on the identifier of the first receiver. In some embodiments, the information includes an indication of a binding level associated with the first receiver. In additional or alternative embodiments, the information includes a 3gpp-sbi-discovery-target-nf-instance-id and a 3gpp-sbi-discovery-service-names.

At block 1940, processing circuitry 1803 transmits, via network interface 1807, a request message addressing the existing context to a second network node including the information associated with the first receiver. In some embodiments, the request message requests an operation be performed in association with the first context. In additional or alternative embodiments, the operation includes creating the first context or updating the first context.

At block 1950, processing circuitry 1803 receives, via network interface 1807, a response message from the second network node including an identification of a second receiver. In some embodiments, the second receiver has a binding level within a predetermined threshold of the binding level associated with the first receiver. In additional or alternative embodiments, the response message further includes an indication of a location header of a second context.

In some embodiments, the first network node includes an AMF. In additional or alternative embodiments, the second network node includes a SCP. In additional or alternative embodiments, the first receiver is a first SMF and the second receiver is a second SMF. In additional or alternative embodiments, the communications network is a 5G network.

Various operations of FIGS. 19-20 may be optional with respect to some embodiments of network nodes and related methods. For example, regarding the method of Example Embodiment 1 below, for example, operations of blocks 1910, 1920, and 1930 of FIG. 19 and blocks 2010, 2020, and 2030 of FIG. 20 may be optional.

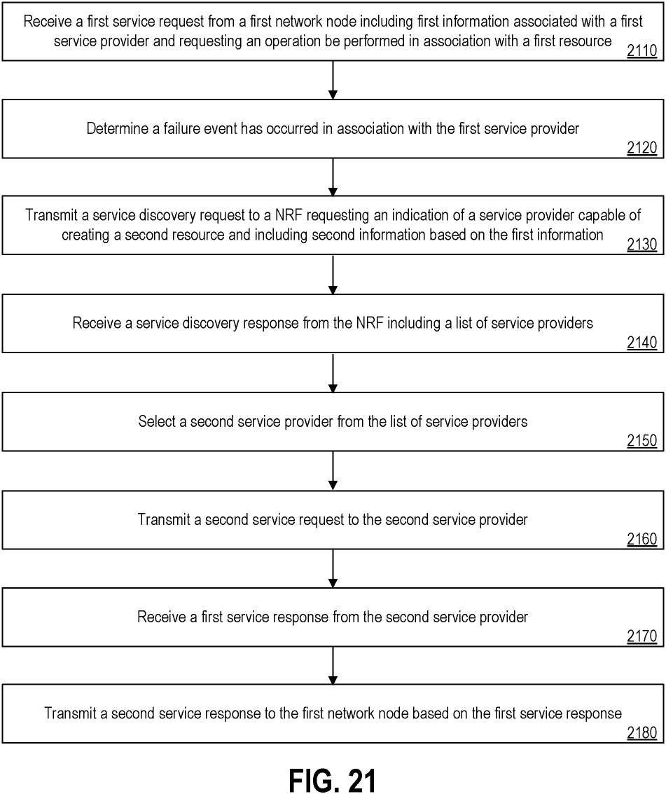

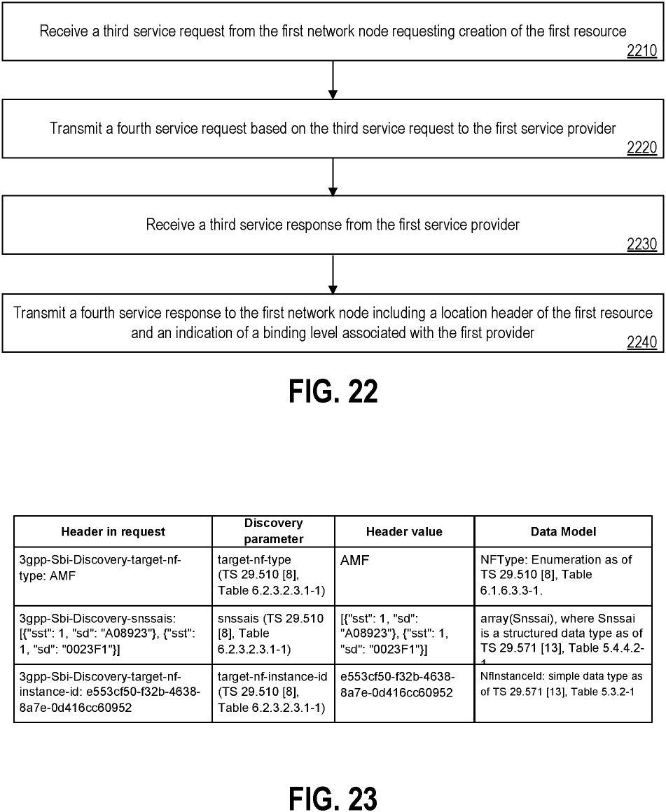

Operations of a second network node will now be discussed with reference to the flow charts of FIGS. 21-22 according to some embodiments of inventive concepts. FIGS. 21-22 will be described below as being performed by a network node (e.g., a core network node including an SCP) as implemented using the structure of the block diagram of FIG. 18). For example, modules may be stored in memory 1805 of FIG. 18, and these modules may provide instructions so that when the instructions of a module are executed by respective processing circuitry 1803, processing circuitry 1803 performs respective operations of the flow charts. However, the operations in FIGS. 21-22 may be performed by any suitable network node.

### FIG. 21

FIG. 21 illustrates an example of operations performed by a second network node (e.g., a SCP node) in accordance with some embodiments.

At block 2110, processing circuitry 1803 receives, via network interface 1807, a first request message addressing a first context in a first receiver from a first network node including first information associated with the first context in the first receiver. In some embodiments, the request message requests an operation be performed in association with a first context. In additional or alternative embodiments, the operation includes at least one of creating the first context and updating the first context.

At block 2120, processing circuitry 1803 determines a failure event has occurred in association with the first receiver. In some embodiments, the failure event includes the first receiver being unresponsive.

At block 2130, processing circuitry 1803 transmits, via network interface 1807, a discovery request message to a NRF requesting an indication of a receiver capable of creating a second context and including second information based on the first information. In some embodiments, the first information and the second information each include an indication of a binding level associated with the first receiver. In additional or alternative embodiments, the first information includes a 3gpp-sbi-discovery-target-nf-instance-id and a 3gpp-sbi-discovery-service-names.

At block 2140, processing circuitry 1803 receives, via network interface 1807, a discovery response message from the NRF including a list of receivers.

At block 2150, processing circuitry 1803 selects a second receiver from the list of receivers. In some embodiments, selecting the second receiver includes selecting the second receiver based on the second receiver having a binding level within a predetermined threshold of the binding level associated with the first receiver.

At block 2160, processing circuitry 1803 transmits, via network interface 1807, a second request message to the second receiver.

At block 2170, processing circuitry 1803 receives, via network interface 1807, a first response message from the second receiver.

At block 2180, processing circuitry 1803 transmits, via network interface 1807, a second response message to the first network node based on the first response message.

### FIG. 22

FIG. 22 illustrates an example of operations performed by the second network node in creating the first context. At block 2210, processing circuitry 1803 receives, via network interface 1807, a third request message from the first network node requesting creation of the first context. At block 2220, processing circuitry 1803, transmits, via network interface 1807, a fourth request message based on the third request message to the first receiver. At block 2230, processing circuitry 1803 receives, via network interface 1807, a third response message from the first receiver.

At block 2240, processing circuitry 1803 transmits, via network interface 1807, a fourth response message to the first network node including a location header of the first context and an indication of a binding level associated with the first provider. In some embodiments, transmitting the fourth request message based on the third request message to the first receiver includes transmitting a first discovery request message to the NRF. The first discovery request message can request message an indication of a receiver capable of creating the first context to provide the same service to the consumer/producer associated with the first network node and the first discovery request message including the 3gpp-sbi-discovery-dnn. T the fourth request message based on the third request message to the first receiver can further include, responsive to transmitting the first discovery request message, receiving a first discovery response message from the NRF, the first discovery response message including a first list of receivers. Transmitting the fourth request message based on the third request message to the first receiver can include selecting the first receiver from the first list of receivers.

In some embodiments, the first network node includes an AMF. In additional or alternative embodiments, the second network node includes a SCP. In additional or alternative embodiments, the first receiver is a first SMF and the second provider is a second SMF. In additional or alternative embodiments, the communications network is a 5G network.

Various operations of FIGS. 21-22 may be optional with respect to some embodiments of network nodes and related methods. For example, regarding the method of Example Embodiment 16 below, for example, operations of blocks 2210, 2220, 2230, and 2240 of FIG. 22 may be optional.

### EXAMPLE EMBODIMENTS

Example Embodiments are included below.

Embodiment 1. A method of operating a first network node in a communications network configured to operate with indirect communication, the method comprising:
transmitting (1940) a request message addressing a first context in a first receiver to a second network node operating in the communications network, the request message including information associated with the first context; and
responsive to transmitting the request message, receiving (1950) a response message from the second network node including an identification of a second receiver associated with a second context.

Embodiment 2. The method of Embodiment 1, wherein the first context is an existing context in the first receiver, and
wherein the second receiver is able to serve the existing context as same as the first receiver.

Embodiment 3. The method of any of Embodiments 1-2, wherein the information associated with the first context in the first receiver comprises a routing binding indication associated with the first context in the first receiver.

Embodiment 4. The method of any of Embodiments 1-2, wherein the information associated with the first context in the first receiver comprises 3gpp-sbi-discovery* HTTP headers.

Embodiment 5. The method of Embodiment 4, wherein the 3gpp-sbi-discovery* comprises a discovery-target-nf-instance-id and a 3gpp-sbi-discovery-service-names.

Embodiment 6. The method of any of Embodiments 1-5, wherein the first context is an existing context,
wherein the request message is a second request message,
wherein the response message is a second response message,
the method further comprising:
transmitting (1910) a first request message to the second network node, the first request message requesting initialization of the existing context;
responsive to transmitting the first request message, receiving (1920) a first response message including an identifier of the first receiver and without a binding indication; and
generating (1930) the information associated with the existing context based on the identifier of the first receiver.

Embodiment 7. The method of Embodiment 6, further comprising:
transmitting (2010) a discovery request message to a network repository function, NRF, the discovery request message requesting an indication of a receiver capable of serving the existing context;
responsive to transmitting the discovery request message, receiving (2020) a discovery response message from the NRF, the discovery response message including a list of receivers; and
selecting (2030) the first receiver from the list of receivers.

Embodiment 8. The method of Embodiment 6, wherein the first request indicates that the second network node select a receiver capable of serving the existing context.

Embodiment 9. The method of Embodiment 8, wherein the first request message comprises a 3gpp-sbi-routing-indication.

Embodiment 10. The method of Embodiment 1, wherein the first context is a new context,
wherein the first request indicates that the second network node select a receiver capable of creating the new context.

Embodiment 11. The method of any of Embodiments 1-10, wherein the communications network is a 5th Generation, 5G, network,
wherein the first network node comprises a 5G network function other than a service communication proxy, SCP, and a network repository function, NRF,
wherein the second network node comprises the SCP, and
wherein the first receiver and the second receiver each comprise a 5G network function other than the SCP and the NRF.

Embodiment 12. The method of Embodiment 11, wherein the first network node is associated with a consumer,
wherein the first receiver is associated with a first producer,
wherein the second receiver is associated with a second producer;
wherein the first context is associated with a first resource
wherein the second context is associated with a second resource, and
wherein the request message requests the first producer create or update the first resource.

Embodiment 13. The method of Embodiment 12, wherein the first network node comprises an access and mobility management function, AMF,
wherein the first receiver is a first session management function, SMF, and
wherein the second receiver is a second SMF.

Embodiment 14. The method of Embodiment 11, wherein the first network node is associated with a producer,
wherein the first receiver is associated with a first consumer, and
wherein the second receiver is associated with a second consumer,

Embodiment 15. The method of Embodiment 14, wherein the first network node comprises a session management function, SMF,
wherein the first receiver is an access and mobility management function, AMF, and
wherein the second receiver is a second AMF.

Embodiment 16. A method of operating a second network node in a communications network configured to operate with indirect communication, the method comprising:
receiving (2110) a first request message addressing a first context in a first receiver from a first network node operating in the communications network, the first request message including first information associated with the first context in the first receiver;
determining (2120) a failure event has occurred in association with the first receiver; and
responsive to determining that the failure event has occurred, transmitting (2130) a discovery request message to a network repository function, NRF, the discovery request message requesting an indication of a receiver capable of serving a context as the first receiver serves the first context and the discovery request message including second information based on the first information;
responsive to transmitting the discovery request message, receiving (2140) a discovery response message from the NRF, the discovery response message including a list of receivers;
selecting (2150) a second receiver from the list of receivers;
responsive to selecting the second receiver, transmitting (2160) a second request message to the second receiver, the second request message based on the first request message;
responsive to transmitting the second request message, receiving (2170) a first response message from the second receiver; and
responsive to receiving the first response message, transmitting (2180) a second response message to the first network node, the second response message including an identification of the second receiver.

Embodiment 17. The method of Embodiment 16, wherein the first information and the second information each comprise information to select a list of receivers capable of serving a context as the first receiver served the first context.

Embodiment 18. The method of Embodiment 17, wherein selecting the second receiver comprises selecting the second receiver based on the routing binding indication received from the first network node.

Embodiment 19. The method of any of Embodiments 16-17, wherein the information associated with the first receiver comprises HTTP 3gpp-sbi-discovery* headers.

Embodiment 20. The method of Embodiment 19, wherein 3gpp-sbi-discovery* comprises a 3gpp-sbi-discovery-target-nf-instance-id and a 3gpp-sbi-discovery-service-names.

Embodiment 21. The method of any of Embodiments 16-20, wherein the first context is an existing context,
the method further comprising:
   receiving (2210) a third request message from the first network node, the third request message requesting creation of the existing context;
   responsive to receiving the third request message, transmitting (2220) a fourth request message based on the third request message to the first receiver;
   responsive to transmitting the fourth request message, receiving (2230) a third response message from the first receiver; and
   responsive to receiving the third response message, transmitting (2240) a fourth response message to the first network node

Embodiment 22. The method of Embodiment 21, wherein the third response message from the first receiver includes a binding indication of a binding level of the first receiver, and
wherein the fourth response message includes an indication of the binding level of the first receiver.

Embodiment 23. The method of Embodiment 22, wherein the third response message from the first receiver fails to include a binding indication of the binding level of the first receiver, and
wherein the fourth response message includes a 3gpp-sbi-prodcuer-id header including an indication of the network function, NF, instance identification, ID, of the first receiver.

Embodiment 24. The method of any of Embodiments 21-23, wherein the discovery request message is a second discovery request message,
wherein the discovery response message is a second discovery response message,
wherein the list of receivers is a second list of receivers,
wherein the first request message includes a 3gpp-sbi-discovery-dnn and indicates that the second network node select a receiver capable of initializing the existing context,
wherein transmitting the fourth request message based on the third request message to the first receiver further comprises:
   transmitting a first discovery request message to the NRF, the first discovery request message requesting an indication of a receiver capable of initializing the existing context and the first discovery request message including the 3gpp-sbi-discovery-dnn;
   responsive to transmitting the first discovery request message, receiving a first discovery response message from the NRF, the first discovery response message including a first list of receivers; and
   selecting the first receiver from the first list of receivers.

Embodiment 25. The method of any of Embodiments 16-24, wherein the first response message from the second receiver fails to include a binding indication indicating a binding level of the second receiver, and
wherein the second response message to the first network node includes a 3gpp-sbi-prodcuer-id header including an indication of the network function, NF, instance identification, ID, of the second receiver.

Embodiment 26. The method of any of Embodiments 16-25, wherein the communications network is a 5th Generation, 5G, network,
wherein the first network node comprises a 5G network function other than a service communication proxy, SCP, and a network repository function, NRF,
wherein the second network node comprises the SCP, and
wherein the first receiver and the second receiver each comprise a 5G network function other than the SCP and the NRF.

Embodiment 27. The method of Embodiment 26, wherein the first network node is associated with a consumer,
wherein the first receiver is associated with a first producer,
wherein the second receiver is associated with a second producer;
wherein the first context is associated with a first resource
wherein the second context is associated with a second resource, and
wherein the first request message requests the first producer create or update the first resource.

Embodiment 28. The method of Embodiment 27, wherein the first network node comprises an access and mobility management function, AMF,
wherein the first receiver is a first session management function, SMF, and
wherein the second receiver is a second SMF.

Embodiment 29. The method of Embodiment 26, wherein the first network node is associated with a producer,
wherein the first receiver is associated with a first consumer, and
wherein the second receiver is associated with a second consumer,

Embodiment 30. The method of Embodiment 29, wherein the first network node comprises a session management function, SMF,
wherein the first receiver is an access and mobility management function, AMF, and
wherein the second receiver is a second AMF.

Embodiment 31. A first network node (1800) operating in a communications network configured to operate with indirect communication, the network node comprising:
processing circuitry (1803); and
memory (1805) coupled with the processing circuitry, wherein the memory includes instructions that when executed by the processing circuitry causes the network node to perform operations, the operations comprising:
   transmitting (1940) a request message addressing a first context in a first receiver to a second network node operating in the communications network, the request message including information associated with the first context; and
   responsive to transmitting the request message, receiving (1950) a response message from the second network node including an identification of a second receiver associated with a second context.

Embodiment 32. The first network node of Embodiment 31, wherein the first context is an existing context in the first receiver,
wherein the second receiver is able to serve the existing context as same as the first receiver.

Embodiment 33. The first network node of Embodiment 32, wherein the information associated with the first context in the first receiver comprises a routing binding indication associated with the first context in the first receiver.

Embodiment 34. The first network node of any of Embodiments 31-33, wherein the information associated with the first context in the first receiver comprises 3gpp-sbi-discovery* HTTP headers.

Embodiment 35. The first network node of Embodiment 34, wherein the 3gpp-sbi-discovery* comprises a discovery-target-nf-instance-id and a 3gpp-sbi-discovery-service-names.

Embodiment 36. The first network node of any of Embodiments 31-35, wherein the first context is an existing context,
wherein the request message is a second request message,
wherein the response message is a second response message,
   the operations further comprising:
      transmitting (1910) a first request message to the second network node, the first request message requesting initialization of the existing context;
      responsive to transmitting the first request message, receiving (1920) a first response message including an identifier of the first receiver and without a binding indication; and
      generating (1930) the information associated with the existing context based on the identifier of the first receiver.

Embodiment 37. The first network node of Embodiment 36, operations further comprising:
transmitting (2010) a discovery request message to a network repository function, NRF, the discovery request message requesting an indication of a receiver capable of serving the existing context;
responsive to transmitting the discovery request message, receiving (2020) a discovery response message from the NRF, the discovery response message including a list of receivers; and
selecting (2030) the first receiver from the list of receivers.

Embodiment 38. The first network node of Embodiment 36, wherein the first request indicates that the second network node select a receiver capable of serving the existing context.

Embodiment 39. The first network node of Embodiment 38, wherein the first request message comprises a 3gpp-sbi-routing-indication.

Embodiment 40. The first network node of Embodiment 31, wherein the first context is a new context,
wherein the first request indicates that the second network node select a receiver capable of creating the new context.

Embodiment 41. The first network node of any of Embodiments 31-40, wherein the communications network is a 5th Generation, 5G, network,
wherein the first network node comprises a 5G network function other than a service communication proxy, SCP, and a network repository function, NRF,
wherein the second network node comprises the SCP, and
wherein the first receiver and the second receiver each comprise a 5G network function other than the SCP and the NRF.

Embodiment 42. The first network node of Embodiment 41, wherein the first network node is associated with a consumer,
wherein the first receiver is associated with a first producer,
wherein the second receiver is associated with a second producer;
wherein the first context is associated with a first resource
wherein the second context is associated with a second resource, and
wherein the request message requests the first producer create or update the first resource.

Embodiment 43. The first network node of Embodiment 42, wherein the first network node comprises an access and mobility management function, AMF,
wherein the first receiver is a first session management function, SMF, and
wherein the second receiver is a second SMF.

Embodiment 44. The first network node of Embodiment 43, wherein the first network node is associated with a producer,
wherein the first receiver is associated with a first consumer, and
wherein the second receiver is associated with a second consumer,

Embodiment 45. The first network node of Embodiment 44, wherein the first network node comprises a session management function, SMF,
wherein the first receiver is an access and mobility management function, AMF, and
wherein the second receiver is a second AMF.

Embodiment 46. A first network node (1800) operating in a communications network configured to operate with indirect communication and adapted to perform operations, the operations comprising:
transmitting (1940) a request message addressing a first context in a first receiver to a second network node operating in the communications network, the request message including information associated with the first context; and
responsive to transmitting the request message, receiving (1950) a response message from the second network node including an identification of a second receiver associated with a second context.

Embodiment 47. The first network node of Embodiment 46, further adapted to perform any of the operations of Embodiments 2-15.

Embodiment 48. A computer program comprising program code to be executed by processing circuitry (1803) of a first network node (1800) operating in a communications network configured to operate with indirect communication, whereby execution of the program code causes the first network node to perform operations, the operations comprising:
transmitting (1940) a request message addressing a first context in a first receiver to a second network node operating in the communications network, the request message including information associated with the first context; and
responsive to transmitting the request message, receiving (1950) a response message from the second network node including an identification of a second receiver associated with a second context.

Embodiment 49. The computer program of Embodiment 48, whereby execution of the program code further causes the first network node to perform any of the operations of Embodiments 2-15.

Embodiment 50. A computer program product comprising a non-transitory storage medium including program code to be executed by processing circuitry (1803) of a first network node (1800) operating in a communications network configured to operate with indirect communication, whereby execution of the program code causes the first network node to perform operations, the operations comprising:
transmitting (1940) a request message addressing a first context in a first receiver to a second network node operating in the communications network, the request message including information associated with the first context; and
responsive to transmitting the request message, receiving (1950) a response message from the second network node including an identification of a second receiver associated with a second context.

Embodiment 51. The computer program product of Embodiment 50, whereby execution of the program code further causes the first network node to perform any of the operations of Embodiments 2-15.

Embodiment 52. A second network node (1800) operating in a communications network configured to operate with indirect communication, the network node comprising:
processing circuitry (1803); and
memory (1805) coupled with the processing circuitry, wherein the memory includes instructions that when executed by the processing circuitry causes the network node to perform operations, the operations comprising:
   receiving (2110) a first request message addressing a first context in a first receiver from a first network node operating in the communications network, the first request message including first information associated with the first context in the first receiver;
   determining (2120) a failure event has occurred in association with the first receiver; and
      responsive to determining that the failure event has occurred, transmitting (2130) a discovery request message to a network repository function, NRF, the discovery request message requesting an indication of a receiver capable of serving a context as the first receiver serves the first context and the discovery request message including second information based on the first information;
      responsive to transmitting the discovery request message, receiving (2140) a discovery response message from the NRF, the discovery response message including a list of receivers;
      selecting (2150) a second receiver from the list of receivers;
      responsive to selecting the second receiver, transmitting (2160) a second request message to the second receiver, the second request message based on the first request message;
      responsive to transmitting the second request message, receiving (2170) a first response message from the second receiver; and
      responsive to receiving the first response message, transmitting (2180) a second response message to the first network node, the second response message including an identification of the second receiver.

Embodiment 53. The second network node of Embodiment 52, wherein the first information and the second information each comprise information to select a list of receivers capable of serving a context as the first receiver served the first context.

Embodiment 54. The second network node of Embodiment 53, wherein selecting the second receiver comprises selecting the second receiver based on the routing binding indication received from the first network node.

Embodiment 55. The second network node of any of Embodiments 52-54, wherein the information associated with the first receiver comprises HTTP 3gpp-sbi-discovery* headers.

Embodiment 56. The second network node of Embodiment 55, wherein 3gpp-sbi-discovery* comprises a 3gpp-sbi-discovery-target-nf-instance-id and a 3gpp-sbi-discovery-service-names.

Embodiment 57. The second network node of any of Embodiments 52-55, wherein the first context is an existing context,
the operations further comprising:
   receiving (2210) a third request message from the first network node, the third request message requesting creation of the existing context;
   responsive to receiving the third request message, transmitting (2220) a fourth request message based on the third request message to the first receiver;
   responsive to transmitting the fourth request message, receiving (2230) a third response message from the first receiver; and
   responsive to receiving the third response message, transmitting (2240) a fourth response message to the first network node

Embodiment 58. The second network node of Embodiment 57, wherein the third response message from the first receiver includes a binding indication of a binding level of the first receiver, and
wherein the fourth response message includes an indication of the binding level of the first receiver.

Embodiment 59. The second network node of Embodiment 58, wherein the third response message from the first receiver fails to include a binding indication of the binding level of the first receiver, and
wherein the fourth response message includes a 3gpp-sbi-prodcuer-id header including an indication of the network function, NF, instance identification, ID, of the first receiver.

Embodiment 60. The second network node of any of Embodiments 57-59, wherein the discovery request message is a second discovery request message,
wherein the discovery response message is a second discovery response message,
wherein the list of receivers is a second list of receivers,
wherein the first request message includes a 3gpp-sbi-discovery-dnn and indicates that the second network node select a receiver capable of initializing the existing context,
wherein transmitting the fourth request message based on the third request message to the first receiver further comprises:
   transmitting a first discovery request message to the NRF, the first discovery request message requesting an indication of a receiver capable of initializing the existing context and the first discovery request message including the 3gpp-sbi-discovery-dnn;
   responsive to transmitting the first discovery request message, receiving a first discovery response message from the NRF, the first discovery response message including a first list of receivers; and
   selecting the first receiver from the first list of receivers.

Embodiment 61. The second network node of any of Embodiments 52-60, wherein the first response message from the second receiver fails to include a binding indication indicating a binding level of the second receiver, and
wherein the second response message to the first network node includes a 3gpp-sbi-prodcuer-id header including an indication of the network function, NF, instance identification, ID, of the second receiver.

Embodiment 62. The second network node of any of Embodiments 52-61, wherein the communications network is a 5th Generation, 5G, network,
wherein the first network node comprises a 5G network function other than a service communication proxy, SCP, and a network repository function, NRF,
wherein the second network node comprises the SCP, and
wherein the first receiver and the second receiver each comprise a 5G network function other than the SCP and the NRF.

Embodiment 63. The second network node of Embodiment 62, wherein the first network node is associated with a consumer,
wherein the first receiver is associated with a first producer,
wherein the second receiver is associated with a second producer;
wherein the first context is associated with a first resource
wherein the second context is associated with a second resource, and
wherein the first request message requests the first producer create or update the first resource.

Embodiment 64. The second network node of Embodiment 63, wherein the first network node comprises an access and mobility management function, AMF,
wherein the first receiver is a first session management function, SMF, and
wherein the second receiver is a second SMF.

Embodiment 65. The second network node of Embodiment 62, wherein the first network node is associated with a producer,
wherein the first receiver is associated with a first consumer, and
wherein the second receiver is associated with a second consumer,

Embodiment 66. The second network node of Embodiment 65, wherein the first network node comprises a session management function, SMF,
wherein the first receiver is an access and mobility management function, AMF, and
wherein the second receiver is a second AMF.

Embodiment 67. A second network node (1800) operating in a communications network configured to operate with indirect communication and adapted to perform operations, the operations comprising:
receiving (2110) a first request message addressing a first context in a first receiver from a first network node operating in the communications network, the first request message including first information associated with the first context in the first receiver;
determining (2120) a failure event has occurred in association with the first receiver; and
responsive to determining that the failure event has occurred, transmitting (2130) a discovery request message to a network repository function, NRF, the discovery request message requesting an indication of a receiver capable of serving a context as the first receiver serves the first context and the discovery request message including second information based on the first information;
responsive to transmitting the discovery request message, receiving (2140) a discovery response message from the NRF, the discovery response message including a list of receivers;
   selecting (2150) a second receiver from the list of receivers;
   responsive to selecting the second receiver, transmitting (2160) a second request message to the second receiver, the second request message based on the first request message;
   responsive to transmitting the second request message, receiving (2170) a first response message from the second receiver; and
   responsive to receiving the first response message, transmitting (2180) a second response message to the first network node, the second response message including an identification of the second receiver.

Embodiment 68. The second network node of Embodiment 67, further adapted to perform any of the operations of Embodiments 17-30.

Embodiment 69. A computer program comprising program code to be executed by processing circuitry (1803) of a second network node (1800) operating in a communications network configured to operate with indirect communication, whereby execution of the program code causes the second network node to perform operations, the operations comprising:
receiving (2110) a first request message addressing a first context in a first receiver from a first network node operating in the communications network, the first request message including first information associated with the first context in the first receiver;
determining (2120) a failure event has occurred in association with the first receiver; and
responsive to determining that the failure event has occurred, transmitting (2130) a discovery request message to a network repository function, NRF, the discovery request message requesting an indication of a receiver capable of serving a context as the first receiver serves the first context and the discovery request message including second information based on the first information;
responsive to transmitting the discovery request message, receiving (2140) a discovery response message from the NRF, the discovery response message including a list of receivers;
selecting (2150) a second receiver from the list of receivers;
responsive to selecting the second receiver, transmitting (2160) a second request message to the second receiver, the second request message based on the first request message;
responsive to transmitting the second request message, receiving (2170) a first response message from the second receiver; and
responsive to receiving the first response message, transmitting (2180) a second response message to the first network node, the second response message including an identification of the second receiver.

Embodiment 70. The computer program of Embodiment 69, whereby execution of the program code further causes the second network node to perform any of the operations of Embodiments 16-30.

Embodiment 71. A computer program product comprising a non-transitory storage medium including program code to be executed by processing circuitry (1803) of a second network node (1800) operating in a communications network configured to operate with indirect communication, whereby execution of the program code causes the second network node to perform operations, the operations comprising:
receiving (2110) a first request message addressing a first context in a first receiver from a first network node operating in the communications network, the first request message including first information associated with the first context in the first receiver;
determining (2120) a failure event has occurred in association with the first receiver; and
responsive to determining that the failure event has occurred, transmitting (2130) a discovery request message to a network repository function, NRF, the discovery request message requesting an indication of a receiver capable of serving a context as the first receiver serves the first context and the discovery request message including second information based on the first information;
responsive to transmitting the discovery request message, receiving (2140) a discovery response message from the NRF, the discovery response message including a list of receivers;
selecting (2150) a second receiver from the list of receivers;
responsive to selecting the second receiver, transmitting (2160) a second request message to the second receiver, the second request message based on the first request message;
responsive to transmitting the second request message, receiving (2170) a first response message from the second receiver; and
responsive to receiving the first response message, transmitting (2180) a second response message to the first network node, the second response message including an identification of the second receiver.

Embodiment 72. The computer program product of Embodiment 71, whereby execution of the program code further causes the second network node to perform any of the operations of Embodiments 16-30.

Some abbreviations used above are described below.

| | |
|---|---|
| Abbreviation | Explanation |
| AMF | Access and Mobility Management Function |
| BS | Base station |
| CRC | Cyclic Redundancy Check |
| CRM | Contention Resolution Message |
| DCI | Downlink Control Information |
| DL | Downlink |
| DM-RS | Demodulation Reference Signal |
| eMTC | Enhanced Machine Type Communication |
| FH | Frequency Hopping |
| FR1 | Frequency Range 1 |
| FR2 | Frequency Range 2 |
| HARQ | Hybrid Automated Retransmission Request |
| MAC | Medium Access Control |

| | |
|---|---|
| Msg3 | Message 3 |
| NB-loT | Narrow-Band Internet of Things |
| NR-U | NR unlicensed |
| PDCCH | Physical Downlink Control Channel |
| PUSCH | Physical Uplink Shared Data Channel |
| PRACH | Physical Random Access Channel |
| PRB | Physical Resource Block, i.e. 12 consecutive subcarriers |
| RACH | Random Access Channel |
| RA | Random Access |
| RAR | Random Access Response |
| RO | PRACH occasion |
| RSRP | Reference Signal Received Power |
| TB | Transport Block |
| RNTI | Radio Network Temporary Identifier |
| TxD | Transmit Diversity |
| UE | User Equipment |
| UL | Uplink |
| gNB | (Base station) |

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

### ENCLOSURES

Details of the embodiments described above are further specified below:
3GPP TSG-CT WG4 Meeting #99e C4-204abc
E-Meeting, 18th - 28th August 2020
CR-Form-v12.0
CHANGE REQUEST
29.527 Current version: 16.3.0
Proposed change affects: Core Network X
Title: Reselection when the Routing Binding Indication unavailable
Source to WG: Ericsson
Source to TSG: CT4
Work item code: 5G_eSBA Date: 2020-08-05
Category: F Release: Rel-16

Reason for change: When reselecting of a NF Service Instance by the SCP while the Routing Binding Indication is not available, it is not clear which parameters that the SCP can use to make the reselection.

It should be documented how reselection of a NF service consumer to receive Notification or Callback request.

Summary of change: When reselecting of a NF Service Instance by the SCP while the Routing Binding Indication is not available, the SCP may use use NF service discovery factors which are conveyed by the″3gpp-Sbi-Discovery-*” request headers if the NF Service Consumer includes in the request message;

Proposed a set of requirements similar to the reselection of NF service producer for the reselection of NF service consumer.

Consequences if not approved: The SCP is unable to perform a reselection of NF Service Instance when the Routing Binding Indication is not available. Reselection of a NF Service Consumer may not work.

Clauses affected: 6.5.3, 6.×.1, 6.×.2, 6.×.3

### * * * First Change * * * *

6.5.3 NF Service Instance Reselection when a (Routing) Binding Indication is not available

If a formerly selected NF Service Instance becomes unavailable, the NF Service Consumer or SCP may select a different instance of a same NF Service in:
the same NF Instance, if the NF Instance indicates in its NF Profile that it supports the capability to persist their resources in shared storage inside the NF Instance, and if the new NF Service Instance offers the same major service version; or
the same NF Set or NF Service Set, if the NF (service) instance indicates in its NF Profile that it belongs to an NF Set or an NF Service Set.

If so, the NF Service Consumer or SCP may invoke service operations in the newly selected NF Service Instance by means of replacing the addressing parameters with those of the new service instance, and the new NF Service Instance in the NF Service Producer shall produce the same result as if the service operation request would have been successfully delivered to the former NF Service Instance.

For indirect communication, the SCP may use NF service discovery factors which are conveyed by the″3gpp-Sbi-Discovery-*” request headers (if the NF Service Consumer includes in the request message) to perform NF service discovery procedures and reselect a NF (service) instance, if the target NF Service Instance, as indicated in the “3gpp-Sbi-Target-apiRoot” header or in the target URI, is not reachable.

NOTE: This reselection mechanism is applicable only for the request/response service semantics, but not for notify/callback requests.

If the NF instance does not indicate in its NF Profile the support of the capability to persist their resources in shared storage across service instances of the same NF Service, inside the NF Instance, and if it does not indicate in its NF Profile that it belongs to an NF Set or an NF Service Set, the NF Service Consumer or SCP may still reselect any of the exposed service instances, but it shall not assume that the resources created in the former service instance are still valid.

### * * * Next Change * * * *

6.× NF Service Consumer Reselection
6.×.1 General

When NF (Service) Set is deployed in the network as specified in clause 5.21.3 and 6.3.1.0 of 3GPP TS 23.501[9], an NF Service Consumer in an NF (Service) Set may create a session context for callback (corresponding to the resource context in the NF Service Producer) when invoking a NF Service and the session context data is shared by all NF (Service) instances pertaining to the same NF (Service) set, i.e. the context is bound to the NF (Service) Set.

An NF Service Producer or SCP may discover, via NRF Nnrf_NFDiscovery service, all available NF (Service) Instances within the NF (service) set is able to receive notifications or callback request from the NF Service Producer and select one of them.

### * * * Next Change * * * *

6.×.2 NF Service Consumer Reselection when a (Routing) Binding Indication is available

When using the Binding procedures specified in clause 6.12 of 3GPP TS 29.500 [10], Binding Indications and Routing Binding Indications include the Binding level and one or more Binding entity IDs representing all NF service consumer instances that are capable to serve notifications or callback requests targeting the session context for callback (corresponding to the resource context in the NF Service Producer).

When a Binding Indication or a Routing Binding Indication is available for a target context, NF Service Consumer selection and re-selection shall be supported as specified in clause 6.12 of 3GPP TS 29.500 [10].

### * * * Next Change * * * *

6.×.3 NF Service Consumer Reselection when a (Routing) Binding Indication is not available

When the target NF Service Consumer becomes unavailable, the NF Service Producer or SCP may select a different instance of the Service Consumer which is capable to serve notifications or callback requests targeting the session context for callback (corresponding to the resource context in the NF Service Producer) in:
the same NF instance e.g. multiple endpoint address information is configured, which may be per NF instance level, or per NF service instance level if the the name of the NF service to which these notifications are to be sent is known;
the same NF Set or a backup NF Service Consumer if applicable.

NOTE 1: The NF Service Consumer can provide the name of the NF service to which these notifications are to be sent (this service can be one of the service produced by the NF (if this NF Service Consumer can also serve as a NF Service Producer) and registered in the NRF or a custom service registered in the NRF for the purpose of receiving these notifications). See clause 6.5.2.2 of 3GPP TS 29.500 [10].

NOTE 2: When the AMF serves as a NF Service Consumer, it can indicate to the NF Service Producer its backup AMF. See clause 5.21.2 of 3GPP TS 23.501[9].

If so, the NF Service Producer or SCP may send notification or callback request to the newly selected NF Service Consumer Instance by means of replacing the addressing parameters with the newly selected.

For indirect communication, the SCP may use NF service discovery factors which are conveyed by the″3gpp-Sbi-Discovery-*” request headers (if the NF Service Producer includes in the request message) to perform NF service discovery procedures and reselect a NF (service) instance, if the target NF Service Consumer Instance, as indicated in the “3gpp-Sbi-Target-apiRoot” header or in the target URI is not reachable.

### *** End of Changes * * * *

3GPP TSG-CT WG4 Meeting #99e C4-204abc
E-Meeting, 18th - 28th August 2020
CR-Form-v12.0
CHANGE REQUEST
29.500 Current version: 16.4.0
Proposed change affects: Core Network X
Title: Reselection with indirect communication
Source to WG: Ericsson
Source to TSG: CT4
Work item code: 5G_eSBA Date: 2020-08-05
Category: F (correction) Release: Rel-16

Reason for change: As specified in TS 23.527, clause 6.5, the reselection of the service instance needs consider both when the (Routing) Binding Indication is available or not available.

There are a few issues when come to reselection of a target NF if indirect communication is deployed in a PLMN:
A. regardless whether indirect communication model C or D, it is not clear, in the subsequent request message addressing an existing context in the receiver (either in the Service Producer or in the Service consumer (to receive Notification Request message)), what parameters can SCP use to perform a re-selection of an alternative endpoint, if the Binding Indication is not supported/provided by the receiver earlier (i.e. the service producer or service consumer), where so that the sender is unable to copy the binding indication to routing binding indication to enable the SCP to use it find alternatives.
B. for indirect communication without delegation (Model C), for initial establishment of a resource context in the service provider, if the service consumer has selected a specific service instance (i.e. instead of selecting a NF (service) Set), there is no way for the SCP to perform a reselection if the NF service instance selected by the Service Consumer is not reachable.

Considering that the SCP is assumed to either use ““ (e.g. for addressing existing context), or use “3gpp-Sbi-Discovery-*” (e.g. when the service consumer has just selected the target NF (service) Set for Model C, and for Mode D with discovery delegation), for above two cases, it is proposed, the sender may include a routing binding indication which is built on its own, or a “3gpp-Sbi-Discovery-*” (e.g. 3gpp-sbi-discovery-target-nf-instance-id, 3gpp-sbi-discovery-service-names, 3gpp-sbi-discovery-target-nf-set-id, 3gpp-sbi-discovery-target-service-set-id″, based on the information e.g. to which NF (service) set the intended receiver pertain.

Summary of change: When sending a request message to address an existing context while the binding indication (in corresponding to the context) is not received earlier from the target NF, to enable SCP perform a reselection of the target NF, it is proposed that:
the sender may include a 3gpp-Sbi-Routing-Binding header which is constructed on its own based on the NF profile of the target NF; or
the sender may include 3gpp-Sbi-Discovery* headers based on the NF profile of the target NF;
   Correct a few inconsistent requirements, e.g. “ A Routing Binding Indication shall be contained in an HTTP request.”.
   Consequences if not approved: The SCP is unable to perform a reselection of NF (service) instance.
   Clauses affected: 5.2.3.2.5, 5.2.3.2.7, 6.10.3.2, 6.10.3.4, 6.10.5.1, 6.12.1

### * * * First Change * * * *

5.2.3.2.5 3gpp-Sbi-Routing-Binding

This header contains a Routing Binding Indication which is used by the SCP to direct a service request to an HTTP NF service producer server which has the targeted NF service resource context, or a notification or a callback request to a NF service consumer (see clause 6.12). The Routing Binding Indication is a copy of the information in the Binding Indication (see clause 5.2.3.2.6 and clause 6.3.1.0 of 3GPP TS 23.501 [3]) if it is available; otherwise the sender may create a Routing Binding Indication based on the NF Profile of the target NF (service) Instance to enable the SCP perform a reselection, e.g. when the NF Service resource owner instance is part of an NF set (or AMF set) or an NF service set, or its NF profile indicates that its supports NF service persistence within the NF instance (see clause 6.5 of 3GPP TS 23.527 [38]).

The encoding of the header follows the ABNF as defined in IETF RFC 7230 [12].

3gpp-Sbi-Routing-Binding = “3gpp-Sbi-Routing-Binding″ “:” OWS “bl=” blvalue 1*( OWS “;” parameter)
blvalue= “nf-instance” / “nf-set” / “nfservice-instance” / “nfservice-set”
parameter = parametername “=” token
parametername = “nfinst” / “nfset” / “nfservinst” / “nfserviceset” / “servname”
The following parameters are defined:
   bl (binding level): the value of this parameter (blvalue) indicates a preferred binding to a binding entity, i.e. either to an NF Instance, an NF set, an NF Service Instance or an NF Service Set. If the binding level is set to an NF Service Instance (nfservice-instance), then either NF Service Set ID or NF Instance ID shall also be present to unambiguously identify the NF Service Instance.
   nfinst (NF instance): indicates an NF Instance ID, as defined in clause 5.2.2.2.2 in 3GPP TS 29.510 [8]. This parameter shall be present if the binding level is set to “nf-instance”, or if the binding level is set to “nfservice-instance” and the nfserviceset parameter is not included.
   nfset (NF set): indicates an NF Set ID, as defined in clause 28.12 in 3GPP TS 23.003 [15]. This parameter shall be present if the binding level is set to “nf-set”. It may be present otherwise (see clause 6.12.1).
   nfservinst (NF service instance): indicates an NF Service Instance ID. This parameter shall be present if the binding level is set to “nfservice-instance”.
   nfserviceset (NF service set): indicates an NF Service Set ID as defined in clause 28.13 in 3GPP TS 23.003 [15]. This parameter shall be present if the binding level is set to “nfservice-set”. It may be present if the binding level is set to “nfservice-instance” (see clause 6.12.1).
   servname (service name): indicates the name of a service, as defined in 3GPP TS 29.510 [8], or a custom service that handles a notification or a callback request. It may be present in a Routing Binding Indication in a notification or a callback request.

See clause 3.2.6 of IETF RFC 7230 [12] for the “token” type definition. A token’s value is a string, which contains a binding entity ID or a service name.

### Example 1 Binding to SMF Set 1 of MCC 345 and MNC 012

3gpp-Sbi-Routing-Binding: bl=nf-set; nfset=set1.smfset.5gc.mnc012.mcc345

### Example 2 Binding to an SMF Instance Within SMF Set of Example 1

3gpp-Sbi-Routing-Binding: bl=nf-instance; nfinst=54804518-4191-46b3-955c-ac631f953ed8; nfset=set1.smfset.5gc.mnc012.mcc345

### Example 3: Binding to a SMF Service Set “xyz” Within an SMF Instance Within SMF Set of Example 1

3gpp-Sbi-Routing-Binding: bl=nfservice-set; nfservset=setxyz.snnsmfpdusession.nfi54804518-4191-46b3-955c-ac631f953ed8.5gc.mnc012.mcc345; nfset=set1.smfset.5gc.mnc012.mcc345

### Example 4 Binding to AMF Set 1 Within AMF Region 48 (Hexadecimal)

3gpp-Sbi-Routing-Binding: bl=nf-set; nfset=set1.region48.amfset.5gc.mnc012.mcc345

### Example 5: Binding for a Subscription (i.e. Notification Requests) to AMF Set 1 Within AMF Region 48 (Hexadecimal) and Namf_Communication Service

3gpp-Sbi-Routing-Binding: bl=nf-set; nfset= set1.region48.amfset.5gc.mnc012.mcc345; servname=namf-comm

### Next Change

5.2.3.2.7 3gpp-Sbi-Discovery

These headers shall be used to convey NF service discovery factors to the SCP in indirect communication models. They contain discovery parameters to be conveyed by the a NF service consumer or a NF service producer to the SCP(s) and shall be used by the SCP to select or reselect for finding a suitable NF service producer instance to create or update a (existing) resource context, or a suitable NF service consumer to receive a notification or callback request, e.g. the SCP may by performing the NF service discovery procedure with the NRF on behalf of the NF consumer in case of indirect communication with delegated discovery model.

The name of each NF service discovery factors header shall be constructed by concatenating the string “3gpp-Sbi-Discovery-” with the name of the conveyed discovery parameter, i.e. “3gpp-Sbi-Discovery-<discovery parameter>”.

The discovery headers shall be used to include any of the discovery query parameters listed in 3GPP TS 29.510 [8], Table 6.2.3.2.3.1-1. The value of each NF service discovery header shall be encoded in the same way as the corresponding discovery parameter (i.e. with the same data type and cardinality). Thus, the values of these headers may be validated with the same data model as that of the corresponding discovery parameters. The discovery headers shall comply with the condition of presence of the discovery parameters defined in Table 6.2.3.2.3.1-1 of 3GPP TS 29.510 [8], e.g. discovery headers shall be included for discovery parameters defined as mandatory in this table. Table 5.2.3.2.7-1 lists examples of NF service discovery headers.

FIG. 23FIG. 23 includes table 5.2.3.2.7-1, which illustrates NF service discovery factors headers examples. The 3gpp-Sbi-Discovery-* header is not documented in OpenAPI specification files. It shall comply with the following OpenAPI definition:

headers:
3gpp-Sbi-Discovery-<Discovery parameter name>:
description: Discovery parameter defined in Table 6.2.3.2.3.1-1 of 3GPP TS
29.510
schema:
type: <Data type defined in Table 6.2.3.2.3.1-1 of 3GPP TS 29.510>

### Next Change

6.10.3.2 Conveyance of NF Discovery Factors

When the NF service consumer is configured to use delegated service discovery, it shall include in the HTTP/2 request message the necessary NF service discovery factors to be used by the SCP to perform NF service discovery procedures on behalf of the NF service consumer. The latter shall convey these NF service discovery factors using the″3gpp-Sbi-Discovery-*” request headers. How to set the values of these “3gpp-Sbi-Discovery-*” request headers is detailed in clause 5.2.3.2.7.

If the “3gpp-Sbi-Routing-Binding” header is not included in the HTTP/2 request message, the NF service consumer may include the “3gpp-Sbi-Discovery-*” headers in the HTTP/2 request message (which is addressing an existing resource context in the NF service producer) to enable the SCP to perform a reselection of the NF service producer, e.g. when the NF service producer which is already indicated in “3gpp-Sbi-Target-apiRoot” header is not reachable.

Based on SCP configuration, an SCP deciding to address a next-hop SCP for a service request may delegate the NF instance and/or service instance discovery and selection to subsequent SCPs, in which case it shall forward the “3gpp-Sbi-Discovery-*” request headers to the next-hop SCP.

When receiving from the NF service consumer a service request containing “3gpp-Sbi-Discovery-*” request headers and when the selection/reselection of the receiving NF is required, and the SCP is to invoke NF service discovery towards the NRF to fulfil this task, then it shall take into account all the NF service discovery factors contained in the “3gpp-Sbi-Discovery-*” request headers. It is also possible for the SCP to be internally configured to fulfil these service discovery tasks without interacting with the NRF.

NOTE: The SCP can determine “3gpp-Sbi-Discovery-*” headers are only used for reselection e.g. based on the presence of “3gpp-Sbi-Target-apiRoot” header.

If the service request contains “3gpp-Sbi-Discovery-*” request header(s) that are not supported by the SCP, the latter should include the corresponding query parameters in the discovery request to the NRF. Based on operator policy, the SCP may alternatively reject the request and return a response with the status code “400 Bad Request” to the NF service consumer with an “lNVALlD_DlSCOVERY_ PARAM” error.

### Next Change

6.10.3.4 Returning the NF Service Producer ID to the NF Service Consumer

When using delegated discovery, if and only if the NF Service Producer does not return a Binding Indication in a service response creating a resource, the SCP that (re)selected the target NF service instance shall include the 3gpp-Sbi-Producer-ld header in the HTTP response it forwards towards the NF Service Consumer, containing the NF Instance ID of the NF Service Producer selected by the SCP (see clause 6.10.3.2). The NF Service Consumer may include “3gpp-Sbi-Discovery-*” request headers, e.g. the 3gpp-Sbi-Discovery-target-nf-instance-id header set to the NF Instance ID of the NF Service Producer as received in 3gpp-Sbi-Producer-ld header and the 3gpp-Sbi-Discovery-service-names, in the subsequent request addressing the same resource context, to enable the SCP perform a reselection if needs.
NOTE 1: This allows to support deployments where not all NF Service Producers have been upgraded to support the binding procedures.
NOTE 2: In scenarios where the same NF Service Producer needs to be selected when creating new resources, e.g. when the AMF needs to establish a new PDU session towards the same SMF as the one selected for a previous PDU session, the NF Service Consumer can include the 3gpp-Sbi-Discovery-target-nf-instance-id header set to the NF Instance ID of the NF Service Producer in the request creating the new resource.
NOTE 3: An SCP needs not insert a 3gpp-Sbi-Producer-Id header in an HTTP response if it received a 3gpp-Sbi-Target-apiRoot header in the related HTTP request and it did not reselect a different NF Service Producer.

### Next Change

6.10.5.1 General

For Indirect Communication without Delegated Discovery, the NF Service Consumer performs the discovery procedure by querying the NRF and the selection of a NF (Service) Set or a specific NF (service) instance . The selection of the target NF service instance may hence be done either by the NF Service Consumer or the SCP (e.g. based on NF (Service) Set information received from the NF Service Consumer).

The NF Service Consumer shall send its request to the SCP containing:
the 3gpp-Sbi-Target-apiRoot header set to the apiRoot of the selected NF service instance, if the SCP is known to the NF Service Consumer and if the NF Service Consumer has selected a specific NF service instance;
the NF Service Consumer may include “3gpp-Sbi-Discovery-*” request headers in the request messages, e.g. 3gpp-Sbi-Discovery-target-nf-set-id, 3gpp-Sbi-Discovery-target-nf-service-set-id, to enable the SCP to perform a reselection if the one indicated in the 3gpp-Sbi-Target-apiRoot header or in the apiRoot is not reachable.
the identity of the selected NF (Service) Set in the associated “3gpp-Sbi-Discovery-*” request header(s) (see clause 6.10.3.2), if the NF Service Consumer has selected a target NF (Service) Set ID.

If the request does not include the apiRoot of a selected NF service instance, or if the SCP needs to reselect a different NF service instance, the SCP shall select an NF service instance using the NF (Service) Set ID received in the corresponding “3gpp-Sbi-Discovery-*” request header(s), if available.

The SCP shall then route the request to the selected NF service instance of the target NF service producer.

If the NF Service Producer does not return a Binding Indication in a service response, the SCP that reselected the target NF service instance shall include the 3gpp-Sbi-Producer-Id header in the HTTP response it forwards towards the NF Service Consumer, containing the NF Instance ID of the NF Service Producer selected by the SCP.

### Next Change

6.12.1 General

A Binding Indication for an NF Service Resource may be provided to an NF Service Consumer of the resource as part of the Direct or Indirect Communication procedures, to be used in subsequent related service requests. This allows the NF Service Resource owner to indicate that the NF Service Consumer, for a particular resource, should be bound to an NF service instance, NF instance, NF service set or NF set. See clause 6.3.1.0 of 3GPP TS 23.501 [3] and clause 4.17.12 of 3GPP TS 23.502 [4].

A binding may be established or updated as part of a:
1) service response creating or modifying a resource, to be used for subsequent requests targeting this resource (see clause 4.17.12.2 of 3GPP TS 23.502 [4]), for any API that defines resources;
2) service request, if the NF Service Consumer can also act as an NF Service Producer for later communication from the contacted NF Service Producer, to be used for subsequent service requests initiated by the contacted NF Service Producer (see clause 4.17.12.3 of 3GPP TS 23.502 [4]);
3) service request creating or modifying an explicit or an implicit subscription, or as part of a notification response, to be used for subsequent notification requests initiated by the NF Service Producer (see clause 4.17.12.3 of 3GPP TS 23.502 [4]);
4) service response creating an implicit or explicit subscription or updating a subscription, or as part of a notification request, to be used for subsequent operations on the subscription (see clause 4.17.12.4 of 3GPP TS 23.502 [4]);
5) service request creating a callback (other than notification) resource (e.g. V-SMF or I-SMF callback URI sent to the H-SMF or SMF), or as part of a callback response, to be used for subsequent callback requests initiated by the NF Service Producer (e.g. H-SMF or SMF initiated PDU session modification).

Two types of binding information are defined to manage the binding between an NF Service Consumer and an NF Service Resource:
1) A Binding Indication conveys binding information for a resource which must be stored by the consumer (client) of that resource and used by the client to direct future requests to the resource. When contained in a service request, the binding information is associated with a resource owned by the NF Service Consumer for the current transaction. When contained in a service response, the binding information is associated with a resource owned by the NF Service Producer for the current transaction.
2) A Routing Binding Indication conveys binding information to direct a request from a client to a server which has the resource context. A Routing Binding Indication shall only be contained in an service HTTP request.

A same service request may convey more than one Binding Indication, e.g.:
to provide bindings for notification or callback (i.e. bullets 3 or 5) and for other services that the NF service consumer can provide later as a NF Service Producer (i.e. bullet 2); or
to provide binding information for different event notifications, when creating a subscription on behalf of another NF (see clause 6.12.4).

The scope parameter in a Binding Indication in a service request identifies the applicability of (i.e. scenario associated with) the binding information.

A service request may convey one or more Binding Indications as described above using a 3gpp-Sbi-Binding header and/or include a Binding Routing Indication to influence routing of the request e.g. to an appropriate set of NF Service Producers or to an appropriate service set of the NF Service Producer using a 3gpp-Sbi-Routing-Binding header. A service response may convey a Binding Indication for a resource using a 3gpp-Sbi-Binding header.

NOTE 1: An HTTP request can contain for instance one 3gpp-Sbi-Binding header containing two Binding Indications for other services and for callbacks, and one 3gpp-Sbi-Routing-Binding header conveying a Routing Binding Indication.

If an SCP receives a Routing Binding Indication within a service or notification request and decides to forward that request to a next-hop SCP, it shall include the Routing Binding Indication in the forwarded request.

Binding Indications and Routing Binding Indications shall include the Binding level and one or more Binding entity IDs representing all NF service instances that are capable to serve service requests targeting the resource, i.e. that share the same resource contexts.

The Binding Level indicates a preferred binding to either a NF Instance, a NF set, a NF Service Instance or a NF Service Set. When sending a request targeting the resource, the binding entity corresponding to the binding level shall be selected whenever possible. If this is not possible, e.g. because the preferred binding entity is not reachable, the request should be sent to any other Binding entity signalled in the Binding Indication or Routing Binding Indication, in the following decreasing order of priority:
select an NF service instance in the same NF service set, if a NF service Set ID was signalled in the Binding Indication or Routing Binding Indication;
select an equivalent NF service instance in the same NF instance, if an NF instance ID was signalled in the Binding Indication or Routing Binding Indication;
select an NF service instance in an equivalent NF service set of another NF instance of the NF set, if an NF Service Set ID and an NF Set ID were signalled in the Binding Indication or Routing Binding Indication;
select an equivalent NF service instance in another NF instance of the NF Set, if an NF Set ID was signalled in the Binding Indication or Routing Binding Indication.

NOTE 2: NF service instances from different NF instances are equivalent NF service instances if they share the same MCC, MNC, NID (for SNPN), ServiceName, API version, and, if applicable, NF Service Set ID (see clause 28.13 of 3GPP TS 23.003 [15]).

Binding Indications shall not be used if a particular resource can only be served by a specific NF service instance of an NF instance, i.e. if NF service instances of a same NF service are not capable to share resource inside the NF Instance. A resource for which no Binding Indication or Routing Binding Indication is signalled shall be considered to be bound exclusively to one NF service instance, unless the NF Service resource owner instance is part of an NF set (or AMF set) or an NF service set, or unless its NF profile in the NRF indicates that its supports NF service persistence within the NF instance (see clause 6.5 of 3GPP TS 23.527 [38]).

1. A method of operating a first network node in a communications network configured to operate with indirect communication, the method comprising:
transmitting a request message addressing a first context in a first receiver to a second network node operating in the communications network, the request message including information associated with the first context; and
responsive to transmitting the request message, receiving a response message from the second network node including an identification of a second receiver associated with a second context.

2. The method of claim 1, wherein the first context is an existing context in the first receiver, and
wherein the second receiver is able to serve the existing context as same as the first receiver.

3. The method of claim 1, wherein the information associated with the first context in the first receiver comprises a routing binding indication associated with the first context in the first receiver.

4. (canceled)

5. (canceled)

6. The method of claim 1, wherein the first context is an existing context,
wherein the request message is a second request message,
wherein the response message is a second response message,
the method further comprising:
transmitting a first request message to the second network node, the first request message requesting initialization of the existing context;
responsive to transmitting the first request message, receiving a first response message including an identifier of the first receiver and without a binding indication; and
generating the information associated with the existing context based on the identifier of the first receiver.

7. The method of claim 6, further comprising:
transmitting a discovery request message to a network repository function, NRF, the discovery request message requesting an indication of a receiver capable of serving the existing context;
responsive to transmitting the discovery request message, receiving a discovery response message from the NRF, the discovery response message including a list of receivers; and
selecting the first receiver from the list of receivers.

8. (canceled)

9. (canceled)

10. The method of claim 1, wherein the first context is a new context,
wherein the first request indicates that the second network node select a receiver capable of creating the new context.

11. The method of claim 1, wherein the communications network is a 5^{th} Generation, 5G, network,
wherein the first network node comprises a 5G network function other than a service communication proxy, SCP, and a network repository function, NRF,
wherein the second network node comprises the SCP, and
wherein the first receiver and the second receiver each comprise a 5G network function other than the SCP and the NRF.

12. (canceled)

13. (canceled)

14. (canceled)

15. (canceled)

16. A method of operating a second network node in a communications network configured to operate with indirect communication, the method comprising:
receiving a first request message addressing a first context in a first receiver from a first network node operating in the communications network, the first request message including first information associated with the first context in the first receiver;
determining a failure event has occurred in association with the first receiver; and
responsive to determining that the failure event has occurred, transmitting a discovery request message to a network repository function, NRF, the discovery request message requesting an indication of a receiver capable of serving a second context as the first receiver serves the first context and the discovery request message including second information based on the first information;
responsive to transmitting the discovery request message, receiving a discovery response message from the NRF, the discovery response message including a list of receivers;
selecting a second receiver from the list of receivers;
responsive to selecting the second receiver, transmitting a second request message to the second receiver, the second request message based on the first request message;
responsive to transmitting the second request message, receiving a first response message from the second receiver; and
responsive to receiving the first response message, transmitting a second response message to the first network node, the second response message including an identification of the second receiver.

17. The method of claim 16, wherein the first information and the second information each comprise information to select a list of receivers capable of serving a context as the first receiver served the first context.

18. The method of claim 17, wherein selecting the second receiver comprises selecting the second receiver based on a routing binding indication received from the first network node.

19. (canceled)

20. (canceled)

21. The method of claim 16, wherein the first context is an existing context,
wherein the discovery request message is a second discovery request message,
wherein the discovery response message is a second discovery response message,
wherein the list of receivers is a second list of receivers,
wherein the first request message includes a 3gpp-sbi-discovery-dnn and indicates that the second network node select a receiver capable of initializing the existing context,
the method further comprising:
transmitting a first discovery request message to the NRF, the first discovery request message requesting an indication of a receiver capable of initializing the existing context and the first discovery request message including the 3gpp-sbi-discovery-dnn;
responsive to transmitting the first discovery request message, receiving a first discovery response message from the NRF, the first discovery response message including a first list of receivers; and
selecting the first receiver from the first list of receivers.

22. The method of claim 16, wherein the first response message from the second receiver fails to include a binding indication indicating a binding level of the second receiver, and
wherein the second response message to the first network node includes a 3gpp-sbi-prodcuer-id header including an indication of the network function, NF, instance identification, ID, of the second receiver.

23. The method of claim 16, wherein the communications network is a 5^{th} Generation, 5G, network,
wherein the first network node comprises a 5G network function other than a service communication proxy, SCP, and a network repository function, NRF,
wherein the second network node comprises the SCP, and
wherein the first receiver and the second receiver each comprise a 5G network function other than the SCP and the NRF.

24. (canceled)

25. (canceled)

26. (canceled)

27. (canceled)

28. (canceled)

29. A first network node operating in a communications network configured to operate with indirect communication and adapted to perform the operation of claim 1.

30. (canceled)

31. A computer program product comprising a non-transitory storage medium including program code to be executed by processing circuitry of a first network node operating in a communications network configured to operate with indirect communication, whereby execution of the program code causes the first network node to perform the operation of claim 1.

32. (canceled)

33. A second network node operating in a communications network configured to operate with indirect communication and adapted to perform the operation of claim 16.

34. (canceled)

35. A computer program product comprising a non-transitory storage medium including program code to be executed by processing circuitry of a second network node operating in a communications network configured to operate with indirect communication, whereby execution of the program code causes the second network node to perform the operation of claim 16.
